(19) United States
(12) Patent Application Publication
(10) Pub. No.: US 2008/0107829 A1
(43) Pub. Date: May 8, 2008

(54) Cellulose compound, cellulose film, optical compensation sheet, polarizing plate, and liquid crystal display device

(75) Inventors: Toyohisa Oya, Haibara-gun (JP); Takahiro Kato, Minami-ashigara-shi (JP); Tomoko Imai, Minami-ashigara-shi (JP); Hiroyuki Kawanishi, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/907,389

(22) Filed: Oct. 11, 2007

(30) Foreign Application Priority Data
Oct. 13, 2006 (JP) 2006-280716

(51) Int. Cl. C08F 251/02; B32B 23/04; C09K 19/52

(52) U.S. Cl. 428/1.1; 527/300; 428/532

(57) ABSTRACT

A cellulose film, containing a cellulose compound of formula (I), 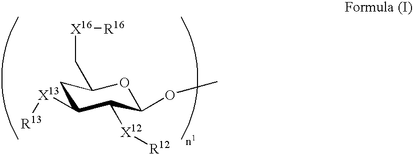
wherein, R¹⁶, R¹³, and R¹² represent a hydrogen atom, or a group containing an aliphatic or aromatic group; —X¹⁶—, —X¹³—, and —X¹²— represent *¹—O—, *¹—OOC—, or *¹—OOCNH—; n¹ represents an average polymerization degree of 10 to 1,500, and the following relationships are satisfied;
   DS¹⁶_{long<(}DS¹³_{long}+DS¹²_{long)} Expression (I)
   2.5≧(DS¹³_{long}+DS¹²_{long}+DS¹⁶_{long})>0.01 Expression (II)
wherein DS¹⁶_{long}, DS¹³_{long}, and DS¹²_{long} represent a substitution degree at the 6-, 3- or 2-position of the substituent having absorption at the longest wavelength, among the 3n¹ substituents on the 6-, 3- or 2-position; and said substituent has an absorption maximum wavelength at the longest wavelength in the range of 270 to 450 nm and a molar extinction coefficient of 2,000 to 1,000,000 for a solution of CH₃—X¹⁶—R¹⁶, CH₃—X¹³—R¹³ or CH₃—X¹²—R¹² corresponding to —X¹⁶—R¹⁶, —X¹³—R¹³ or —X¹²—R¹², respectively.

### FIELD OF THE INVENTION

The present invention relates to a cellulose compound, a cellulose film, an optical compensation sheet, a polarizing plate, and a liquid crystal display device. In particular, the present invention relates to a cellulose film having reverse dispersion of wavelength dispersion of in-plane retardation (Re) and allowing free control of the Re value, and the wavelength dispersion and value of retardation (Rth) in the thickness direction, in wide ranges; a cellulose compound for use therein; and an optical compensation sheet, a polarizing plate, and a liquid crystal display device, prepared by using the cellulose film or cellulose compound.

### BACKGROUND OF THE INVENTION

In recent years, with the prevalence of liquid crystal display devices, increasingly higher levels of display performance and durability are demanded, and hence there are demands for the increase in the response speed, and compensation in a wider range of viewing angles for performances such as the contrast and color balance of a displayed image observed from an oblique direction. In order to solve these problems, display devices in various processes such as VA (Vertical Alignment) process, OCB (Optical Compensated Bend) process, and IPS (In-Plane Switching) process have been developed, and there is a need for various kinds of optical film materials showing retardation that are compatible with respective liquid crystal processes. In particular, it is demanded for retardation films or phase difference films to have values of in-plane retardation (Re) and thickness-direction retardation (Rth) controlled according to various liquid crystal processes. Optical films having controlled retardation values have been studied, to satisfy such demands. For example, optical films prepared by using a fatty acid ester cellulose having an acetyl group or propionyl group are disclosed (JP-A-2001-188128 (“JP-A” means unexamined published Japanese patent application)).

However, such optical films had a Re value of 30 nm or less and a Rth value in the range of 60 to 300 nm, and did not show retardation sufficient for diversified liquid crystal processes. In addition, the wavelength dispersion of retardation (herein, the “wavelength dispersion” means the degree of dispersion of the polarization state (the retardation between fast and slow axes caused by birefringence) of light in a particular wavelength range, and larger dispersion is called higher wavelength dispersion) was not discussed.

Retardation films used in liquid crystal displays have been widely used for attaining high contrast ratios and improving color shift phenomena at wide view angles in color TFT liquid crystal displays of various kinds of display modes, and the like. The types of the retardation films include, for example, a ¼ wavelength plate (hereinafter, abbreviated to as “λ/4 plate”) that converts linearly polarized light into circularly polarized light, and a ½ wavelength plate (hereinafter, abbreviated as “λ/2 plate”) that rotates the polarization vibration face of linearly polarized light by 90°. Conventional retardation films are capable of adjusting monochromatic light to a retardation of λ/4 or λ/2 with respect to light wavelength. However, the conventional retardation films have a problem in that white light, which is a synthesized wave and coexists with light beam in visible light region, is converted into colored polarized light due to generation of distributions for polarization states at the respective wavelengths. This is caused by the fact that a material constituting a retardation film has wavelength dispersion (chromatic dispersion property) for retardation.

For solving such a problem, various kinds of broadband retardation films capable of providing a uniform retardation with respect to a wide-wavelength light have been proposed. For instance, there is disclosed a retardation film obtained by bonding a ¼ wavelength plate where the retardation of birefringent light is ¼ wavelength with a ½ wavelength plate where the retardation of birefringent light is ½ wavelength, with intersecting their optical axes (see, for example, JP-A-10-68816). In addition, there is disclosed a retardation film constructed of at least two retardation films having optical retardation values of 160 to 320 nm, which are laminated at an angle that allows slow phase axes thereof to be neither parallel nor perpendicular to each other (see, for example, JP-A-10-90521).

However, for producing the above retardation films, a complicated process is required for controlling the optical directions (optical axes and slow phase axes) of the two polymer films. For solving such a problem, there is proposed a method of producing a broadband λ/4 plate with a single retardation film, without a lamination of retardation films (see, for example, WO 00/2675).

The method can be preceded by mono-axial orienting using a polymer film which is obtained by copolymerizing a monomer unit for a polymer having positive refractive index anisotropy with a monomer unit for a polymer having a negative birefringence. Since the thus-oriented polymer film has the characteristics of reverse dispersion of wavelength dispersion (herein, the “reverse dispersion of wavelength dispersion” means that the absolute values of the in-plane retardation (Re1) of a light at a particular wavelength and the in-plane retardation (Re2) of a light at a longer wavelength are both positive, and the value of Re1 divided by Re2 (Re1/Re2) is less than 1.0), it is possible to prepare a broadband λ/4 plate using one retardation film. However, the obtained retardation values are within a narrow range, so many films should be laminated otherwise the sufficient optical characteristics cannot be obtained. As a result, a polarizing plate to be prepared is made thick and heavy.

Along with increasing demand for reduction in the thickness and production costs of the panels in liquid crystal display devices, there have been studied with methods of imparting the aforementioned function as a retardation film to a protective film for the polarizing plates to be used in liquid crystal display devices.

Cellulose acylate films have been used widely as polarizing plate-protective films for liquid crystal display devices, because of their favorable transparency, toughness and optical isotropy. For example, an optical film prepared by casting a fatty acid acylate mixed ester of cellulose, such as cellulose acetate propionate or cellulose acetate butyrate, was proposed (JP-A-2005-352620). Although these cellulose fatty esters are favorable materials that have a potential for expanding the retardation efficiency of cellulose acetate, a single film of the cellulose fatty ester did not show sufficient reverse dispersion of wavelength dispersion, prohibiting use as a polarizing plate-protective film also functioning as a retardation film.

On the other hand, an optical film of an aromatic group-containing cellulose, specifically an aromatic carboxylic ester of cellulose acylate, was proposed, but the optical properties including retardation thereof are not described, and the substitution position and substitution degree of the aromatic groups in the cellulose acylate are also not described (JP-A-2002-179701). As for cellulose acylates having aromatic substituents substituted at specific positions, preparation of 2,3-di-O-acetyl-6-O-benzoyl-cellulose and 6-O-acetyl-2,3-di-O-benzoyl-cellulose was reported, but the application thereof is limited to optically active column, and no studies on application thereof to film and on the optical properties thereof were carried out (Chirality (2000), 12(9), 670-674).

### SUMMARY OF THE INVENTION

The present invention resides in a cellulose film, which contains a cellulose compound represented by formula (I),

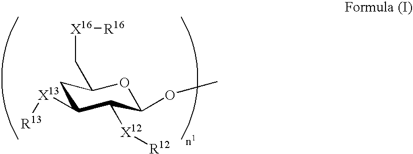

wherein, R¹⁶, R¹³, and R¹² each independently represent a hydrogen atom, or a group containing an aliphatic or aromatic group; —X¹⁶—, —X¹³—, and —X¹²— each independently represent *¹—O—, *¹—OOC—, or *¹—OOCNH— (in which *¹ represents a bond at the side of the six-membered ring of cellulose skeleton); n¹ represents an average polymerization degree of an integer of 10 to 1,500; R¹⁶, R¹³, R¹², —X¹⁶—, —X¹³—, and —X¹²—, each of which is present in the number of n¹ in the cellulose compound, may be the same as or different from each other in constituting units; and the following relationships as represented by Expression (I) and Expression (II) are satisfied;
DS¹⁶_{long}<(DS¹³_{long}+DS¹²_{long}) Expression (I)
2.5≧(DS¹³_{long}+DS¹²_{long}+DS¹⁶_{long})>0.01 Expression (II)

wherein DS¹⁶_{long}, DS¹³_{long}, and DS¹²_{long} represent a substitution degree at the 6-, 3- or 2-position of the substituent having absorption at the longest wavelength, among the 3n¹ substituents substituting on the 6-, 3- or 2-position as —X¹⁶—R¹⁶, —X¹³—R¹³, or —X¹²—R¹², respectively; and said substituent having absorption at the longest wavelength is a substituent having an absorption maximum wavelength at the longest wavelength in the range of 270 to 450 nm and having a molar extinction coefficient of 2,000 to 1,000,000 for a solution of compound CH₃—X¹⁶—R¹⁶, CH₃—X¹³—R¹³ or CH₃—X¹²—R¹² corresponding to —X¹⁶—R¹⁶, —X¹³—R¹³ or —X¹²—R¹², respectively.

The present invention also resides in a retardation film, a polarizing plate, an optical compensation film (also referred to as an optical compensation sheet), an antireflection film, and a liquid crystal display device, comprising the cellulose film; and a cellulose compound represented by formula (I).

Other and further features and advantages of the invention will appear more fully from the following description.

### DETAILED DESCRIPTION OF THE INVENTION

According to the present invention, there are provided the following means:
(1) A cellulose film, containing a cellulose compound represented by formula (I),

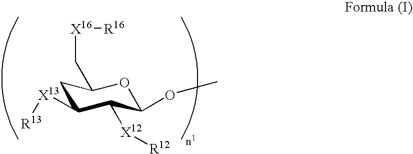

wherein, R¹⁶, R¹³, and R¹² each independently represent a hydrogen atom, or a group containing an aliphatic or aromatic group; —X¹⁶—, —X¹³—, and —X¹²— each independently represent *¹—O—, *¹—OOC—, or *¹—OOCNH— (in which *¹ represents a bond at the side of the six-membered ring of cellulose skeleton); n¹ represents an average polymerization degree of an integer of 10 to 1,500; R¹⁶, R¹³, R¹², —X¹⁶, —X¹³—, and —X¹²—, each of which is present in the number of n¹ in the cellulose compound, may be the same as or different from each other in constituting units; and the following relationships as represented by Expression (I) and Expression (II) are satisfied;
DS¹⁶_{long}<(DS¹³_{long}+DS¹²_{long}) Expression (I)
2.5≧(DS¹³_{long}+DS¹²_{long}+DS¹⁶_{long})>0.01 Expression (II)

wherein DS¹⁶_{long}, DS¹³_{long}, and DS¹²_{long} represent a substitution degree at the 6-, 3- or 2-position of the substituent having absorption at the longest wavelength, among the 3n¹ substituents substituting on the 6-, 3- or 2-position as —X¹⁶—R¹⁶, —X¹³—R¹³, or —X¹²—R¹², respectively; and said substituent having absorption at the longest wavelength is a substituent having an absorption maximum wavelength at the longest wavelength in the range of 270 to 450 nm and having a molar extinction coefficient of 2,000 to 1,000,000 for a solution of compound CH₃—X¹⁶—R¹⁶, CH₃—X¹³—R¹³ or CH₃—X¹²—R¹² corresponding to —X¹⁶—R¹⁶, —X¹³—R¹³ or —X¹²—R¹², respectively;

(2) The cellulose film as described in the item (1), wherein the substituent having absorption at the longest wavelength among the 3n¹ substituents is a group containing an aromatic group;

(3) The cellulose film as described in the item (1) or (2), wherein substitution degrees of the substituent having absorption at the 2nd longest wavelength among the 3n¹ substituents satisfy the following relationship as represented by Expression (III);
DS¹⁶_{long2}≧(DS¹³_{long2}+DS¹²_{long2}) Expression (III)

wherein DS¹⁶_{long2}, DS¹³_{long2}, and DS¹²_{long2} represent a substitution degree at the 6-, 3- or 2-position of the substituent having absorption at the 2nd longest wavelength, among the 3n¹ substituents substituting on the 6-, 3- or 2-position as —X¹⁶—R¹⁶, —X¹³—R¹³, or —X¹²—R¹², respectively;

(4) The cellulose film as described in any one of the items (1) to (3), wherein the substituent having absorption at the 2nd longest wavelength among the 3n¹ substituents is a group containing an aromatic group;

(5) The cellulose film as described in any one of the items (1) to (4), wherein —X¹⁶—, —X¹³—, and —X¹²— each independently represent *¹—OOC—(in which *¹ represents a bond at the side of the six-membered ring of cellulose skeleton);

(6) The cellulose film as described in any one of the items (1) to (5), wherein at least one group among the 3n¹ groups represented by R¹⁶, R¹³, or R¹² is a group consisting of an aliphatic group;

(7) The cellulose film as described in any one of the items (1) to (6), wherein at least one substituent among the 3n¹ substituents represented by —X¹⁶—R¹⁶, —X¹³—R¹³, or —X¹²—R¹² is —OOC—CH₃;

(8) The cellulose film as described in any one of the items (1) to (7), which is stretched by 0.1% to 500% at least in one direction;

(9) The cellulose film as described in the item (8), wherein the ratio of the absolute value of in-plane retardation at 550 nm (Re(550)) to the absolute value of in-plane retardation at a given wavelength (Re(λ)) satisfies the following relationships as represented by Expressions (IV) and (V);
0.5<Re(450nm)/Re(550nm)<1.0 Expression (IV)
1.05<Re(630nm)/Re(550nm)<1.5 Expression (V)
(10) A retardation film, which comprises the cellulose film as described in any one of the items (1) to (9);
(11) A polarizing plate, comprising a polarizing film, and two protective films which sandwich the polarizing film, wherein at least one of the two protective films is the cellulose film as described in any one of the above items (1) to (9) or the retardation film as described in the above item (10);
(12) An optical compensation film, having an optically anisotropy layer formed by orientating a liquid crystal compound, on the cellulose film as described in any one of the items (1) to (9) or the retardation film as described in the item (10);
(13) An antireflection film, having an antireflection layer, on the cellulose film as described in any one of the items (1) to (9) or the retardation film as described in the item (10);
(14) A liquid crystal display device, comprising at least one selected from the group consisting of the cellulose film as described in any one of the above items (1) to (9), the retardation film as described in the above item (10), the polarizing plate as described in the above item (11), the optical compensation film as described in the above item (12), and the antireflection film as described in the above item (13);
(15) A cellulose compound represented by formula (I):

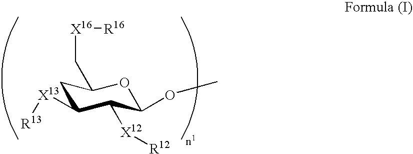

wherein, R¹⁶, R¹³, and R¹² each independently represent a hydrogen atom, or a group containing an aliphatic or aromatic group; —X¹⁶—, —X¹³—, and —X¹²— each independently represent *¹—O—, *¹—OOC—, or *¹—OOCNH— (in which *¹ represents a bond at the side of the six-membered ring of cellulose skeleton); n¹ represents an average polymerization degree of an integer of 10 to 1,500; R¹⁶, R¹³, R¹², —X¹⁶, —X¹³—, and —X¹²—, each of which is present in the number of n¹ in the cellulose compound, may be the same as or different from each other in constituting units; and the following relationships as represented by Expression (I) and Expression (II) are satisfied;
DS¹⁶_{long}<(DS¹³_{long}+DS¹²_{long}) Expression (I)
2.5≧(DS¹³_{long}+DS¹²_{long}+DS¹⁶_{long})>0.01 Expression (II)

wherein DS¹⁶_{long}, DS¹³_{long}, and DS¹²_{long} represent a substitution degree at the 6-, 3- or 2-position of the substituent having absorption at the longest wavelength, among the 3n¹ substituents substituting on the 6-, 3- or 2-position as —X¹⁶—R¹⁶, —X¹³—R¹³, or —X¹²—R¹², respectively; and said substituent having absorption at the longest wavelength is a substituent having an absorption maximum wavelength at the longest wavelength in the range of 270 to 450 nm and having a molar extinction coefficient of 2,000 to 1,000,000 for a solution of compound CH₃—X¹⁶—R¹⁶, CH₃—X¹³—R¹³ or CH₃—X¹²—R¹² corresponding to —X¹⁶—R¹⁶, —X¹³—R¹³ or —X¹²—R¹², respectively; and

(16) The cellulose compound as described in the item (15), wherein at least one group among the 3n¹ groups represented by R¹⁶, R¹³, or R¹² in formula (I) is a hydrogen atom. Hereinafter, the present invention will be explained in detail.

<Cellulose Compound>

In the present invention, the cellulose compound means a compound having a cellulose skeleton obtained by introducing a functional group biologically or chemically into a cellulose used as a raw material.

The cellulose compound contained in the cellulose film of the present invention is represented by formula (I).

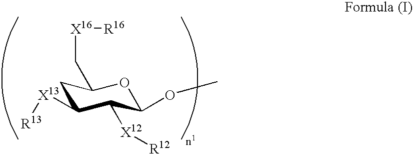

In formula (I), R¹⁶, R¹³, and R¹² each independently represent a hydrogen atom or a group containing an aliphatic or aromatic group. —X¹⁶—, —X¹³—, and —X¹²— each independently represent *¹—O—, *¹—OOC— or *¹—OOCNH— (*¹ represents a bond at the side of the six-membered ring of cellulose skeleton). The combination of —X¹⁶—, —X¹³—, and —X¹²— is not particularly limited, but preferably selected from *¹—O— and *¹—OOC—, and more preferably *¹—OOC—. n¹ represents an average polymerization degree of 10 to 1,500; preferably 50 to 1,000, and most preferably 100 to 500.

With respect to the two glucopyranose rings at the terminals of the cellulose compound according to the present invention, the hydroxyl group at the 1- or 4-position may have a substituent, and the kind of the substituent is not particularly limited. Preferable examples of the substituent include a hydrogen atom; an alkyl group (preferably an alkyl group having from 1 to 24, more preferably from 1 to 18, and particularly preferably from 1 to 12 carbon atoms); an aliphatic acyl group (preferably an aliphatic acyl group having from 2 to 24, more preferably from 2 to 18, and particularly preferably from 2 to 12 carbon atoms); an aromatic acyl group (preferably an aromatic acyl group having from 6 to 30, more preferably from 6 to 24, and particularly preferably from 6 to 20 carbon atoms); the groups represented by —X¹⁶—R¹⁶, —X¹³—R¹³, or —X¹²—R¹² in formula (I) above, and the like.

When R¹⁶, R¹³, or R¹² is a group containing an aromatic group, the aromatic group may be connected directly or via a connecting group to X¹⁶, X¹³, or X¹². The “connecting group” herein means an alkylene, alkenylene, or alkynylene group, and the connecting group may further be substituted. The connecting group is preferably an alkylene, alkenylene, or alkynylene group having 1 or more and 10 or less carbon atoms, more preferably an alkylene or alkenylene group having 1 or more and 6 or less carbon atoms, and most preferably an alkylene or alkenylene group having 1 or more and 4 or less carbon atoms.

The aromatic group may further be substituted. Examples of the substituent substituting on the aromatic group or the substituent substituting on the aforementioned connecting group include an alkyl group (preferably an alkyl group having from 1 to 20, more preferably from 1 to 12, and particularly preferably from 1 to 8 carbon atoms, e.g., methyl, ethyl, propyl, iso-propyl, tert-butyl, n-butyl, n-octyl, n-decyl, n-hexadecyl, cyclopropyl, cyclopentyl, cyclohexyl), an alkenyl group (preferably an alkenyl group having from 2 to 20, more preferably from 2 to 12, and particularly preferably from 2 to 8 carbon atoms, e.g., vinyl, allyl, 2-butenyl, 3-pentenyl), an alkynyl group (preferably an alkynyl group having from 2 to 20, more preferably from 2 to 12, and particularly preferably from 2 to 8 carbon atoms, e.g., propargyl, 3-pentynyl), an aryl group (preferably an aryl group having from 6 to 30, more preferably from 6 to 20, and particularly preferably from 6 to 12 carbon atoms, e.g., phenyl, biphenyl, naphthyl), an amino group (preferably an amino group having from 0 to 20, more preferably from 0 to 10, and particularly preferably from 0 to 6 carbon atoms, e.g., amino, methylamino, dimethylamino, diethylamino, dibenzylamino), an alkoxy group (preferably an alkoxy group having from 1 to 20, more preferably from 1 to 12, and particularly preferably from 1 to 8 carbon atoms, e.g., methoxy, ethoxy, butoxy), an aryloxy group (preferably an aryloxy group having from 6 to 20, more preferably from 6 to 16, and particularly preferably from 6 to 12 carbon atoms, e.g., phenyloxy, 2-naphthyloxy), an acyl group (preferably an acyl group having from 1 to 20, more preferably from 1 to 16, and particularly preferably from 1 to 12 carbon atoms, e.g., acetyl, benzoyl, formyl, pivaloyl), an alkoxycarbonyl group (preferably an alkoxycarbonyl group having from 2 to 20, more preferably from 2 to 16, and particularly preferably from 2 to 12 carbon atoms, e.g., methoxycarbonyl, ethoxycarbonyl), an aryloxycarbonyl group (preferably an aryloxycarbonyl group having from 7 to 20, more preferably from 7 to 16, and particularly preferably from 7 to 10 carbon atoms, e.g., phenyloxycarbonyl), an acyloxy group (preferably an acyloxy group having from 2 to 20, more preferably from 2 to 16, and particularly preferably from 2 to 10 carbon atoms, e.g., acetoxy, benzoyloxy), an acylamino group (preferably an acylamino group having from 2 to 20, more preferably from 2 to 16, and particularly preferably from 2 to 10 carbon atoms, e.g., acetylamino, benzoylamino), an alkoxycarbonylamino group (preferably an alkoxycarbonylamino group having from 2 to 20, more preferably from 2 to 16, and particularly preferably from 2 to 12 carbon atoms, e.g., methoxycarbonylamino), an aryloxycarbonylamino group (preferably an aryloxycarbonylamino group having from 7 to 20, more preferably from 7 to 16, and particularly preferably from 7 to 12 carbon atoms, e.g., phenyloxycarbonylamino), a sulfonylamino group (preferably a sulfonylamino group having from 1 to 20, more preferably from 1 to 16, and particularly preferably from 1 to 12 carbon atoms, e.g., methanesulfonylamino, benzenesulfonylamino), a sulfamoyl group (preferably a sulfamoyl group having from 0 to 20, more preferably from 0 to 16, and particularly preferably from 0 to 12 carbon atoms, e.g., sulfamoyl, methylsulfamoyl, dimethylsulfamoyl, phenylsulfamoyl), a carbamoyl group (preferably a carbamoyl group having from 1 to 20, more preferably from 1 to 16, and particularly preferably from 1 to 12 carbon atoms, e.g., carbamoyl, methylcarbamoyl, diethylcarbamoyl, phenylcarbamoyl), an alkylthio group (preferably an alkylthio group having from 1 to 20, more preferably from 1 to 16, and particularly preferably from 1 to 12 carbon atoms, e.g., methylthio, ethylthio), an arylthio group (preferably an arylthio group having from 6 to 20, more preferably from 6 to 16, and particularly preferably from 6 to 12 carbon atoms, e.g., phenylthio), a sulfonyl group (preferably a sulfonyl group having from 1 to 20, more preferably from 1 to 16, and particularly preferably from 1 to 12 carbon atoms, e.g., mesyl, tosyl), a sulfinyl group (preferably a sulfinyl group having from 1 to 20, more preferably from 1 to 16, and particularly preferably from 1 to 12 carbon atoms, e.g., methanesulfinyl, benzenesulfinyl), a ureido group (preferably a ureido group having from 1 to 20, more preferably from 1 to 16, and particularly preferably from 1 to 12 carbon atoms, e.g., ureido, methylureido, phenylureido), a phosphoric acid amido group (preferably a phosphoric acid amido group having from 1 to 20, more preferably from 1 to 16, and particularly preferably from 1 to 12 carbon atoms, e.g., diethylphosphoric acid amido, phenylphosphoric acid amido), a hydroxy group, a mercapto group, a halogen atom (e.g., fluorine, chlorine, bromine, or iodine atom), a cyano group, a sulfo group, a carboxyl group, a nitro group, a hydroxamic acid group, a sulfino group, a hydrazino group, an imino group, a heterocyclic group (preferably a heterocyclic group having from 1 to 30, and more preferably from 1 to 12 carbon atoms; containing, as a hetero atom(s), for example, a nitrogen atom, an oxygen atom, or a sulfur atom, and specifically, e.g., imidazolyl, pyridyl, quinolyl, furyl, piperidyl, morpholino, benzoxazolyl, benzimidazolyl, benzthiazolyl can be exemplified), and a silyl group (preferably a silyl group having 3 to 40, more preferably 3 to 30, and particularly preferably 3 to 24 carbon atoms, e.g. trimethylsilyl, triphenylsilyl).

These substituents may be further substituted, and if they have two or more substituents, these substituents may be the same or different from each other; or alternatively they may be combined each other, to form a ring, if possible.

The “aromatic group” in the aforementioned “group containing an aromatic group” is not limited to a monovalent group, and may be a bivalent or higher group formed by removing more atoms or groups on the aromatic group.

As for the aromatic group, the term “aromatic” finds a definition in the column of “aromatic compound” in the Dictionary of Science and Chemistry (Iwanami Shoten) 4th Ed., p. 1208, and the aromatic group as described herein agrees with the definition and may be an aromatic hydrocarbon group or an aromatic heterocyclic group, and more preferably an aromatic hydrocarbon group. The aromatic hydrocarbon group preferably has 6 to 24 carbon atoms, more preferably 6 to 12 carbon atoms, and further more preferably 6 to 10 carbon atoms. Specific examples of the aromatic hydrocarbon group include a phenyl group, a naphthyl group, an anthryl group, a biphenyl group, and a terphenyl group. The aromatic hydrocarbon group is particularly preferably a phenyl group, a naphthyl group, or a biphenyl group. The aromatic heterocyclic group preferably contains at least one oxygen atom, nitrogen atom, and/or sulfur atom. Specific examples of heterocycle of the heterocyclic group include furan, pyrrole, thiophene, imidazole, pyrazole, pyridine, pyrazine, pyridazine, triazole, triazine, indole, indazole, purin, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, and tetrazaindene rings. The aromatic heterocyclic group is particularly preferably a pyridyl group, a triazinyl group, or a quinolyl group.

When R¹⁶, R¹³, or R¹² is a group containing an aliphatic group, the group containing an aliphatic group means a group containing no aforementioned aromatic group. Examples thereof include an alkyl group (preferably an alkyl group having from 1 to 20, more preferably from 1 to 12, and particularly preferably from 1 to 8 carbon atoms, e.g., methyl, ethyl, propyl, iso-propyl, tert-butyl, n-butyl, n-octyl, n-decyl, n-hexadecyl, cyclopropyl, cyclopentyl, cyclohexyl, with a methyl group being most preferred), an alkenyl group (preferably an alkenyl group having from 2 to 20, more preferably from 2 to 12, and particularly preferably from 2 to 8 carbon atoms, e.g., vinyl, allyl, 2-butenyl, 3-pentenyl), and an alkynyl group (preferably an alkynyl group having from 2 to 20, more preferably from 2 to 12, and particularly preferably from 2 to 8 carbon atoms, e.g., propargyl, 3-pentynyl). These substituents may be further substituted, and if they have two or more substituents, these substituents may be the same or different from each other; or alternatively they may be combined each other, to form a ring, if possible.

Preferred combinations of —X¹⁶—, —X¹³—, or —X¹²—, with R¹⁶, R¹³, or R¹², respectively, are as follows: In the case where R¹⁶, R¹³, or R¹² is a group containing an aromatic group, preferred are combinations where —X¹⁶—, —X¹³—, or —X¹²— is —O— or —OOC— while R¹⁶, R¹³, or R¹² is a group containing an aromatic hydrocarbon group or aromatic heterocyclic group; more preferred are combinations where —X¹⁶—, —X¹³—, or —X¹²— is —O— or —OOC— while R¹⁶, R¹³, or R¹² is a group containing an aromatic hydrocarbon group; more preferred are combinations where —X¹⁶—, —X¹³—, or —X¹²— is —O— or —OOC— while R¹⁶, R¹³, or R¹² is a phenyl group, a naphthyl group, an anthryl group, a biphenyl group, or a terphenyl group; and most preferred are combinations where —X¹⁶—, —X¹³—, or —X¹²— is —OOC— while R¹⁶, R¹³, or R¹² is a phenyl group, a naphthyl group, or a biphenyl group; and particularly preferred are combinations where the aromatic hydrocarbon group is a phenyl group, a naphthyl group, or a biphenyl group.

In the case where R¹⁶, R¹³, or R¹² is a group having no aromatic group, preferred are combinations where —X¹⁶—, —X¹³—, or —X¹²— is *¹—O— or *¹—OOC— while R¹⁶, R¹³, or R¹² is an alkyl group (preferably an alkyl group having from 1 to 20, more preferably from 1 to 12, and particularly preferably from 1 to 8 carbon atoms, e.g., methyl, ethyl, propyl, iso-propyl, tert-butyl, n-butyl, n-octyl, n-decyl, n-hexadecyl, cyclopropyl, cyclopentyl, cyclohexyl; methyl is most preferred), an alkenyl group (preferably an alkenyl group having from 2 to 20, more preferably from 2 to 12, and particularly preferably from 2 to 8 carbon atoms, e.g., vinyl, allyl, 2-butenyl, 3-pentenyl), and an alkynyl group (preferably an alkynyl group having from 2 to 20, more preferably from 2 to 12, and particularly preferably from 2 to 8 carbon atoms, e.g., propargyl, 3-pentynyl); more preferred are combinations where —X¹⁶—, —X¹³—, or —X¹²— is *¹—O— or *¹—OOC—, while R¹⁶, R¹³, or R¹² is an alkyl group; further preferred are combinations where —X¹⁶—, —X¹³—, or —X¹²— is —O— or —OOC— while R¹⁶, R¹³, or R¹² is a methyl group, an ethyl group, a propyl group, an isopropyl group, a tert-butyl group, or a n-butyl group; and most preferred are combinations where —X¹⁶—, —X¹³, or —X¹²— is —OOC— while R¹⁶, R¹³, or R¹² is a methyl group, an ethyl group, a propyl group, an isopropyl group, a tert-butyl group, or a n-butyl group.

Herein, —X¹⁶—R¹⁶, —X¹³—R¹³, and —X¹²—R¹² may be the same or different from each other.

The cellulose compound of the present invention satisfies the relationships of the following expressions (I) and (II).
DS¹⁶_{long}<(DS¹³_{long}+DS¹²_{long}) Expression (I)
2.5≧(DS¹³_{long}+DS¹²_{long}+DS¹⁶_{long})>0.01 Expression (II)

DS¹⁶_{long}, DS¹³_{long}, and DS¹²_{long} each represent the substitution degree at the 6-, 3- or 2-position of the substituent having absorption at the longest wavelength among the 3n¹ substituents substituting on the 6-, 3- or 2-position as —X¹⁶—R¹⁶, —X¹³—R¹³, or —X¹²—R¹². The “substituent having absorption at the longest wavelength” is a substituent that has an absorption maximum wavelength at the longest wavelength in the range of 270 to 450 nm and a molar extinction coefficient of 2,000 to 1,000,000, for a solution containing compound CH₃—X¹⁶—R¹⁶, CH₃—X¹³—R¹³, or CH₃—X¹²—R¹² derived from —X¹⁶—R¹⁶, —X¹³—R¹³, or —X¹²—R¹², respectively. (In other words, the “substituent having absorption at the longest wavelength” is determined by measuring absorption maximum wavelengths and molar extinction coefficients of solutions respectively containing CH₃—X¹⁶—R¹⁶, CH₃—X¹³—R¹³, or CH₃—X¹²—R¹² converted from the substituent —X¹⁶—R¹⁶, —X¹³—R¹³, or —X¹²—R¹², and selecting therefrom the substituent which has an absorption maximum wavelength at the longest wavelength in the range of 270 nm to 450 nm with a molar extinction coefficient of 2,000 to 1,000,000. If the substituent —X¹⁶—R¹⁶, —X¹³—R¹³, or —X¹²—R¹² in a constituent unit differs from that in another constituent unit, all types of substituents among the 3n¹ substituents on the cellulose compound are to be measured for determining their absorption maximum wavelengths and molar extinction coefficients.) The absorption maximum wavelength is a wavelength where the molar extinction coefficient in solution in the range of 270 to 450 nm is maximal. When the compound CH₃—X¹⁶—R¹⁶, CH₃—X¹³—R¹³, or CH₃—X¹²—R¹² has multiple absorption peaks, the “absorption maximum wavelength” as defined in the present invention is the absorption maximum wavelength of the absorption peak having the longest wavelength. In the present invention, the absorption spectra of solution of the compound CH₃—X¹⁶—R¹⁶, CH₃—X¹³—R¹³, or CH₃—X¹²—R¹² are preferably determined in dichloromethane solution. However, if the solubility of a compound in dichloromethane is low and measurement of the molar extinction coefficient is difficult, a value obtained by dissolving the compound in any good solvent such as chloroform, methanol, acetonitrile, acetone, ethylmethylketone, ethyl acetate, or pyridine may be used instead. In the case of a compound soluble in multiple solvents including dichloromethane, a value as determined in dichloromethane solution is used as the standard.

In the present invention, the substituent having absorption at the longest wavelength preferably contains an aromatic group. The substituent having absorption at the longest wavelength has an absorption maximum wavelength preferably in the range of 210 to 420 nm, more preferably in the range of 230 to 400 nm, and particularly preferably in the range of 240 to 390 nm.

An absorption maximum wavelength of a too-short wavelength may lead to insufficient retardation. Alternatively, an absorption maximum wavelength of a too-long wavelength tends to cause generation of coloring of film and thus cause deterioration of the property as an optical film.

In the present invention, the molar extinction coefficient at the absorption maximum wavelength of the compound CH₃—X¹⁶—R¹⁶, CH₃—X¹³—R¹³, or CH₃—X¹²—R¹² derived from the substituent having absorption at the longest wavelength is in the range of 2,000 to 1,000,000. The unit for the molar extinction coefficient is [L/(mol·cm)]. The molar extinction coefficient is preferably 3,000 to 700,000, more preferably 5,000 to 500,000, and most preferably 7,000 to 100,000. The molar extinction coefficient is preferably larger for obtaining the advantageous effects of the present invention, and a favorable optical film with a hardly detectable coloring of film can be obtained by making the maximum value of molar extinction coefficient in the visible range (wavelength range of 430 to 700 nm) 2,000 or less.

The substituent having absorption at the longest wavelength preferably has a group containing an aromatic group, and more preferably has an absorption maximum wavelength larger by 5 nm or more, most preferably larger by 10 nm or more, than that of the substituent having absorption at the 2nd longest wavelength among the 3n¹ substituents. Herein, the “substituent having absorption at the 2nd longest wavelength” is a substituent having the longest absorption maximum wavelength next to the substituent having absorption at the longest wavelength, for a solution containing compound CH₃—X¹⁶—R¹⁶, CH₃—X¹³—R¹³, and CH₃—X¹²—R¹² derived from —X¹⁶—R¹⁶, —X¹³—R¹³, and —X¹²—R¹², respectively.

In the case where the cellulose compound for use in the present invention does not satisfy the Expression I and the left-hand value (DS¹⁶_{long}) is equal to or greater than the right-hand value (DS¹³_{long}+DS¹²_{long}, it is not possible to obtain sufficient characteristics of reverse dispersion of Re wavelength dispersion. Thus, the effects of the present invention will not be attained.

DS¹⁶_{long}, DS¹³_{long}, and DS¹²_{long} preferably satisfy Expression (VI), more preferably Expression (VI-I), and most preferably Expression (VI-II).

An advantageous effect, i.e. the slope of the Re wavelength dispersion becomes sufficiently large, can be obtained, when the value (DS¹³_{long}+DS¹²_{long})/DS¹⁶_{long} is in the range defined in the following Expression (VI).
1.05<(DS¹³_{long}+DS¹²_{long})/DS¹⁶_{long} Expression (VI)
1.1<(DS¹³_{long}+DS¹²_{long})/DS¹⁶_{long} Expression (VI-I)
1.15<(DS¹³_{long}+DS¹²_{long})/DS¹⁶_{long} Expression (VI-II)

Further, it is preferable that the cellulose compound of the present invention further satisfy the relationship as defined by Expression (III).
DS¹⁶_{long2}≧(DS¹³_{long2}+DS¹²_{long2}) Expression (III)

DS¹⁶_{long2}, DS¹³_{long2}, and DS¹²_{long2} each represent the substitution degree at the 6-, 3-, or 2-position of the substituent having absorption at the 2nd longest wavelength, among the 3n¹ substituents substituting on the 6-, 3- or 2-position as —X¹⁶—R¹⁶, —X¹³—R¹³, or —X¹²—R¹², respectively. DS¹⁶_{long2}, DS¹³_{long2}, and DS¹²_{long2} preferably satisfy Expression (VII), more preferably Expression (VII-I), and most preferably Expression (VII-II).
1<DS¹⁶_{long2}/(DS¹³_{long2}+DS¹²_{long2})≦50 Expression (VII)
1<DS¹⁶_{long2}/(DS¹³_{long2}+DS¹²_{long2})≦30 Expression (VII-I)
1<DS¹⁶_{long2}/(DS¹³_{long2}+DS¹²_{long2})≦10 Expression (VII-II)

The substitution degree of the substituent having absorption at the longest wavelength is preferably 0.01 to 1.25, more preferably 0.02 to 1.0, and particularly preferably 0.05 to 0.8. Further, the substitution degree of the substituent having absorption at the 2nd longest wavelength is preferably 0.01 to 1.25, more preferably 0.02 to 1.0, and particularly preferably 0.05 to 0.8.

(In the cellulose compound according to the present invention, the substitution degree of the “substituent having absorption at the longest wavelength” (hereinafter, also referred to as “longest-wavelength substituent”) is preferably in the aforementioned range, and it corresponds to an average value per constituent unit of the cellulose compound represented by the formula (I). The same applies to the substitution degree of the substituent having absorption at the 2nd longest wavelength.)

In the present invention, the substituents substituting as —X¹⁶—R¹⁶, —X¹³—R¹³, and —X¹²—R¹² preferably include substituents containing an aromatic group and substituents containing no aromatic group; more preferably, the longest-wavelength substituent contain an aromatic group; and most preferably, the longest-wavelength substituent and the 2nd-longest-wavelength substituent each contain an aromatic group.

In the present invention, preferable examples of the substituent substituting as —X¹⁶—R¹⁶, —X¹³—R¹³, or —X¹²—R¹², when it is the longest-wavelength substituent, include 4-methoxybenzoyloxy, 2,4-dimethoxybenzoyloxy, 2,4,5-trimethoxybenzoyloxy, 2,4,6-trimethoxybenzoyloxy, 3,4,5-trimethoxybenzoyloxy, 2,3,4-trimethoxybenzoyloxy, 4-nitrobenzoyloxy, 1-naphthalenecarbonyloxy, 2-naphthalenecarbonyloxy, 2-phenoxybenzoyloxy, 3-phenoxybenzoyloxy, 4-phenylbenzoyloxy, 2-benzoylbenzoyloxy, 3-benzoylbenzoyloxy, 4-benzoylbenzoyloxy, 4-(4′-methoxyphenoxy)benzoyloxy, 4-(4′-methoxyphenoxy)phenylbenzoyloxy, 4-(2,2-dicyanovinyl)benzoyloxy, 4-bromobenzoyloxy, 4-chlorobenzoyloxy, 2,4,6-tribromobenzoyloxy, phenoxypropionyloxy, naphthoxyacetyloxy, naphthoxypropionyloxy, biphenylacetyloxy, biphenyloxyacetyloxy, biphenyloxypropionyloxy, cinnamoyloxy, 4-methoxycinnamoyloxy, 4-phenoxybenzyloxy, 4-benzyloxybenzyloxy, 3,5-dibenzyloxybenzyloxy, biphenyloxyoxy, 4-methoxybenzyloxy, pheylcarbamoyloxy, bipheylcarbamoyloxy, 4-phenoxypheylcarbamoyl, 2-(dicyanomethylene)-3-methyl-2,3-dihydrobenzo[d]thiazole-5-carbonyloxy, and the like.

More preferable examples of the substituent include 4-methoxybenzoyloxy, 2,4-dimethoxybenzoyloxy, 1-naphthalenecarbonyloxy, 2-naphthalenecarbonyloxy, 2-phenoxybenzoyloxy, 3-phenoxybenzoyloxy, 4-phenylbenzoyloxy, 2-benzoylbenzoyloxy, 3-benzoylbenzoyloxy, 4-benzoylbenzoyloxy, 4-(4′-methoxyphenoxy)benzoyloxy, 4-(4′-methoxyphenoxy)phenylbenzoyloxy, 4-(2,2-dicyanovinyl)benzoyloxy, naphthoxyacetyloxy, naphthoxypropionyloxy, biphenylacetyloxy, biphenyloxyacetyloxy, biphenyloxypropionyloxy, cinnamoyloxy, 4-methoxycinnamoyloxy, 2-(dicyanomethylene)-3-methyl-2,3-dihydrobenzo[d]thiazole-5-carbonyloxy, 2,4,5-trimethoxybenzoyloxy, 2,4,6-trimethoxybenzoyloxy, 3,4,5-trimethoxybenzoyloxy, 2,3,4-trimethoxybenzoyloxy, and the like.

Particularly preferable examples of the substituent include 4-methoxycinnamoyloxy, 2-(dicyanomethylene)-3-methyl-2,3-dihydrobenzo[d]thiazole-5-carbonyloxy, 2,4,5-trimethoxybenzoyloxy, 2,4,6-trimethoxybenzoyloxy, 3,4,5-trimethoxybenzoyloxy, 2,3,4-trimethoxybenzoyloxy, and the like.

Preferable examples of the substituent substituting as —X¹⁶—R¹⁶, —X¹³—R¹³ or —X¹²—R¹², when it is the 2nd longest-wavelength substituent, include benzoyloxy, 4-methoxybenzoyloxy, 4-methylbenzoyloxy, 2,4-dimethoxybenzoyloxy, 2,4,5-trimethoxybenzoyloxy, 2,4,6-trimethoxybenzoyloxy, 3,4,5-trimethoxybenzoyloxy, 2,3,4-trimethoxybenzoyloxy, 4-nitrobenzoyloxy, 1-naphthalenecarbonyloxy, 2-naphthalenecarbonyloxy, 2-phenoxybenzoyloxy, 3-phenoxybenzoyloxy, 4-phenylbenzoyloxy, 2-benzoylbenzoyloxy, 3-benzoylbenzoyloxy, 4-benzoylbenzoyloxy, 4-(4′-methoxyphenoxy)benzoyloxy, 4-(4′-methoxyphenoxy)phenylbenzoyloxy, 4-(2,2-dicyanovinyl)benzoyloxy, 4-bromobenzoyloxy, 4-chlorobenzoyloxy, 2,4,6-tribromobenzoyloxy, phenylacetyloxy, phenylpropionyloxy, phenoxyacetyloxy, phenoxypropionyloxy, naphthoxyacetyloxy, naphthoxypropionyloxy, biphenylacetyloxy, biphenyloxyacetyloxy, biphenyloxypropionyloxy, cinnamoyloxy, benzyloxy, 4-phenoxybenzyloxy, 4-benzyloxybenzyloxy, 3,5-dibenzyloxybenzyloxy, biphenyloxyoxy, 4-methoxybenzyloxy, pheylcarbamoyloxy, bipheylcarbamoyloxy, 4-phenoxypheylcarbamoyl, and the like.

Further preferable examples of the substituent include benzoyloxy, 4-methoxybenzoyloxy, 2,4-dimethoxybenzoyloxy, 1-naphthalenecarbonyloxy, 2-naphthalenecarbonyloxy, 2-phenoxybenzoyloxy, 3-phenoxybenzoyloxy, 4-phenylbenzoyloxy, 2-benzoylbenzoyloxy, 3-benzoylbenzoyloxy, 4-benzoylbenzoyloxy, 4-(4′-methoxyphenoxy)benzoyloxy, 4-(4′-methoxyphenoxy)phenylbenzoyloxy, 4-(2,2-dicyanovinyl)benzoyloxy, phenylacetyloxy, phenylpropionyloxy, phenoxyacetyloxy, phenoxypropionyloxy, naphthoxyacetyloxy, naphthoxypropionyloxy, biphenylacetyloxy, biphenyloxyacetyloxy, biphenyloxypropionyloxy, cinnamoyloxy, and the like.

Particularly preferable examples of the substituent include benzoyloxy, 1-naphthalenecarbonyloxy, 2-naphthalenecarbonyloxy, 2-phenoxybenzoyloxy, 3-phenoxybenzoyloxy, 4-phenylbenzoyloxy, 2-benzoylbenzoyloxy, 3-benzoylbenzoyloxy, 4-benzoylbenzoyloxy, phenylacetyloxy, phenylpropionyloxy, phenoxyacetyloxy, phenoxypropionyloxy, naphthoxyacetyloxy, naphthoxypropionyloxy, biphenylacetyloxy, biphenyloxyacetyloxy, biphenyloxypropionyloxy, and the like.

In the present invention, preferred examples of the substituent substituting as —X¹⁶—R¹⁶, —X¹³—R¹³ or —X¹²—R¹² when it is a substituent having no aromatic group, include acetyloxy, propionyloxy, butyryloxy, pentanoyloxy, hexanoyloxy, octanoyloxy, cyclohexanecarbonyloxy, methoxy, ethoxy, hydroxyethoxy, hydroxypropoxy, carboxymethoxy, phthalyloxy, methylcarbamoyloxy, ethylcarbamoyloxy, and the like.

More preferred are acetyloxy, propionyloxy and butyryloxy groups, and particularly preferred is an acetyloxy group.

Each of the glucose units, which constitute cellulose by bonding through β-1,4-glycoside bond, has free hydroxyl groups at the 2-, 3-, and 6-positions thereof. In the present specification, the “substitution degree” means the ratio of substitution of a particular substituent for hydroxyl group(s) at the 2-, 3-, or 6-position. Accordingly, the 100% substitution of all of the 2-, 3-, and 6-positions of cellulose with the substituent gives a substitution degree of 3.0.

The “total substitution degree” in the present invention means the substitution degree of all substituents substituting for the hydroxyl groups at the 2-, 3-, and 6-positions (total degree of substitution on the cellulose compound represented by the formula (I), and this is equivalent to the average value per constituent unit of the cellulose compound), and the total substitution degree of the cellulose compound according to the present invention is preferably 1.0 to 2.99, more preferably 1.5 to 2.99, and particularly preferably 1.7 to 2.95.

In the present invention, the substitution degree of the substituent and the distribution of the substitution degree can be determined by the methods described in Cellulose Communication, 6, 73-79 (1999) and Chirality, 12 (9), 670-674, by ¹H-NMR or ¹³C-NMR.

It is not yet become apparent the reason why a film containing the cellulose compound according to the present invention has a reverse dispersion of wavelength dispersion of in-plane retardation (Re) and allows free control of the Re value and the wavelength dispersion and value of retardation in the thickness direction (Rth), in wide ranges. In the cellulose compound according to the present invention, the conformation of the substituent at the 2- or 3-position is assumed to be different from that of the substituent at the 6-position, and control of their distribution in the range specified in the present invention seems to be effective in providing the advantageous effects of the present invention.

The most preferable examples of the cellulose compound represented by formula (I) are shown in the following Table 1, but the present invention is not limited to these specific examples. In this connection, in Table 1, the DSₙₒₙ₋ₐᵣₒₘₐ is the substitution degree of substituent(s) containing no aromatic group; and the absorption maximum wavelength is the wavelength highest in molar extinction coefficient in the range of 270 to 450 nm, as determined in dichloromethane solution, with the substituents being converted to CH₃—X¹⁶—R¹⁶, CH₃—X¹³—R¹³, and CH₃—X¹²—R¹².

TABLE 1

| | Substituent having | | Substituent having | | | | |
|---|---|---|---|---|---|---|---|
| | absorption at the longest | | absorption at 2nd-longest | | Substituent containing no | | |
| | wavelength | DS¹²_{long} + | wavelength | DS¹⁶_{long2}/ | aromatic group | | Total |
| | (Absorption maximum | DS¹³_{long})/ | (Absorption maximum | DS¹²_{long2} + | (Absorption maximum | | substitution |
| No | wavelength) | DS¹⁶_{long} | wavelength) | DS¹³_{long2}) | wavelength) | DSₙₒₙ₋ₐᵣₒₘₐ | degree |
| A-1 | 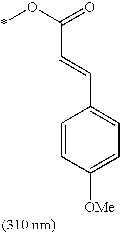 | 0.4/0.15 | 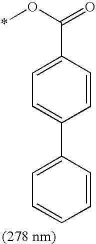 | 0.2/0.04 | 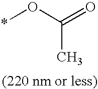 | 2.15 | 2.94 |
| A-2 | 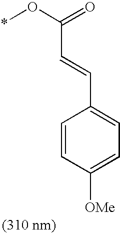 | 0.20/0.15 | 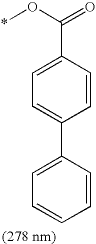 | 0.2/0.04 | 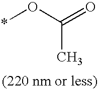 | 2.15 | 2.74 |
| A-3 | 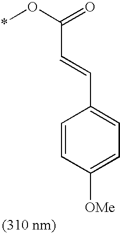 | 0.06/0.05 | 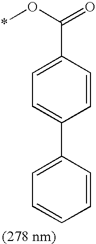 | 0.2/0.04 | 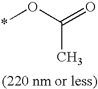 | 2.15 | 2.50 |
| A-4 | 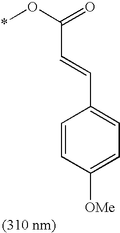 | 0.1/0.02 | 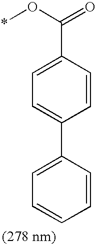 | 0.25/0.1 | 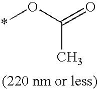 | 2.42 | 2.89 |
| A-5 | 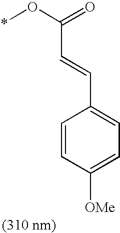 | 0.06/0.02 | 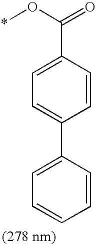 | 0.08/0.05 | 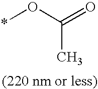 | 2.75 | 2.96 |
| A-6 | 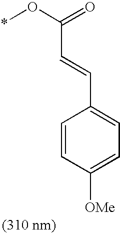 | 0.05/0.01 | 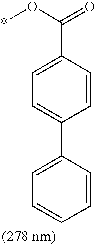 | 0.04/0.01 | 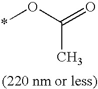 | 2.86 | 2.97 |
| A-7 | 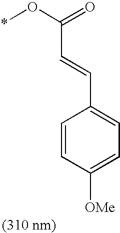 | 0.25/0.1 | 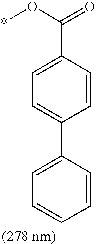 | 0.33/0.12 | 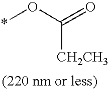 | 1.95 | 2.75 |
| A-8 | 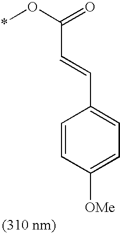 | 0.21/0.11 | 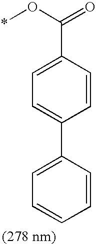 | 0.4/0.15 | 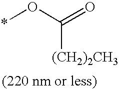 | 1.75 | 2.62 |
| A-9 | 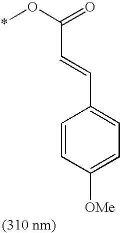 | 0.41/0.11 | 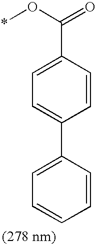 | 0.52/0.21 | 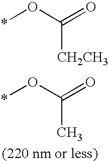 | 1.46 | 2.71 |
| A-10 | 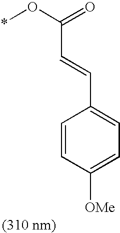 | 0.32/0.12 | 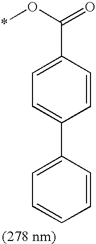 | 0.43/0.18 | 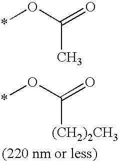 | 1.65 | 2.70 |
| A-11 | 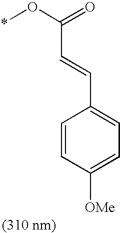 | 0.15/0.05 | 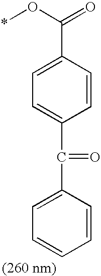 | 0.3/0.04 | 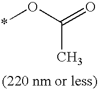 | 2.15 | 2.69 |
| A-12 | 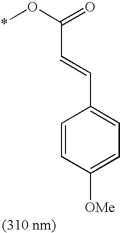 | 0.10/0.07 | 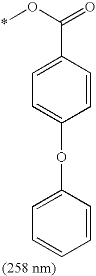 | 0.28/0.04 | 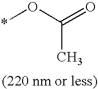 | 2.15 | 2.64 |
| A-13 | 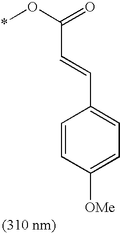 | 0.15/0.06 | 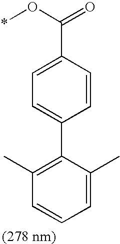 | 0.29/0.06 | 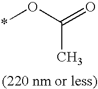 | 2.15 | 2.71 |
| A-14 | 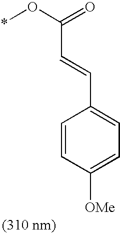 | 0.16/0.09 | 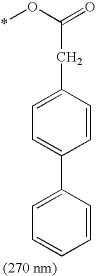 | 0.26/0.25 | 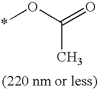 | 2.15 | 2.9 |
| A-15 | 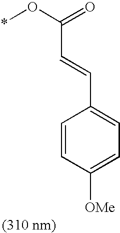 | 0.12/0.05 | 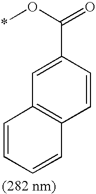 | 0.30/0.08 | 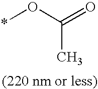 | 2.15 | 2.70 |
| A-16 | 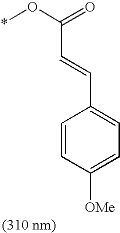 | 0.12/0.05 | 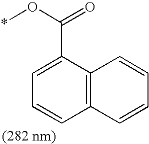 | 0.30/0.08 | 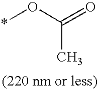 | 2.15 | 2.70 |
| A-17 | 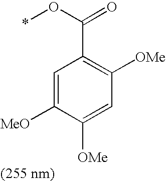 | 0.05/0.03 | 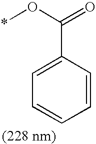 | 0.32/0.01 | 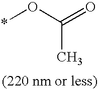 | 2.15 | 2.56 |
| A-18 | 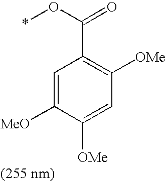 | 0.19/0.07 | 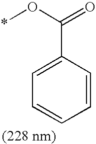 | 0.28/0.11 | 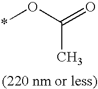 | 2.15 | 2.8 |

The cellulose compound according to the present invention can be prepared according to one or a combination of the general methods described in the following literatures and the references cited therein: “Serurosu no Ziten (Dictionary of Cellulose)” pp. 131-144, edited by The Cellulose Society of Japan, 2000, and “Comprehensive Cellulose Chemistry, Volume 2”, Wiley-Vch, 2001.

The cellulose compound according to the present invention may be prepared by a single step or multiple steps.

In the single-step preparation method, the compound is prepared by esterification of cellulose, with a mixture of two or more esterification agents (e.g., acid anhydrides or acid halides) or a mixed acid anhydride containing two kinds of carboxyl group.

In the multi-step preparation method, cellulose is first esterified into a synthetic intermediate, and the thus-obtained intermediate as the starting material is esterified with another esterification agent in the next step, to give a desirable cellulose compound.

These methods are particularly useful in producing the compound according to the present invention by esterifying a low-priced compound, such as diacetylcellulose, triacetylcellulose, propionylcellulose, butyrylcellulose, cellulose acetate propionate, and cellulose acetate butyrate. In industrial production of cellulose compounds, various unit processes such as esterification, hydrolysis, and depolymerization are occasionally carried out stepwise without isolation of the intermediate. Such a production method is also included in the scope of the multi-step preparation method above.

The cellulose compound according to the present invention is preferably produced by the multi-step preparation method. In this case, it is preferable that esterification by a substituent having absorption at the longest wavelength be carried out in the latter stage, and esterification by a substituent having absorption at a wavelength shorter than that of the aforementioned substituent group be carried out in the earlier stage. Alternatively, such a cellulose compound having a substituent having absorption at a shorter wavelength may be selectively esterified by a substituent having absorption at a longer wavelength.

<Cellulose Compound Raw Cotton>

As the cellulose usable as a raw material of the cellulose compound of the present invention, use can be made of natural celluloses such as cotton linter and wood pulp (e.g., broadleaf pulp, and conifer (needleleaf) pulp), and any cellulose having a low polymerization degree (i.e. polymerization degree of 100 to 300) obtainable by acid hydrolysis of wood pulp, such as microcrystalline cellulose. A plurality of celluloses may be used in combination according to the need. There are detailed descriptions of these raw celluloses in, for example, “Plastic Material Lectures (17), Cellulose Resin” (Marusawa and Uda, The Nikkan Kogyo Shimbun, Ltd., published in 1970); Japan Institute of Invention and Innovation, “Hatsumei Kyokai Kokai Gihou” (Journal of Technical Disclosure) (Kogi No. 2001-1745, Mar. 15, 2001, Japan Institute of Invention and Innovation), pp. 7 to 8; and “Dictionary of Cellulose” p. 523, edited by The Cellulose Society of Japan, Asakura-shoten, 2000, and the raw celluloses described in these publications may be used in the present invention, but these examples are not intended to be limiting of the raw material of the cellulose compound that can be used in the present invention.

<Degree of Polymerization of Cellulose Compound>

The average polymerization degree of cellulose compound that can be used in the present invention is preferably 140 or more and 500 or less. By adjusting the average polymerization degree to 500 or less, the viscosity of a dope solution of the cellulose compound becomes an adequate one and the production of a film by flow casting then tends to be facilitated. In addition, adjusting the average polymerization degree to 140 or more is preferable because the strength of a film formed can be further increased. The average polymerization degree can be measured by a limiting viscosity method by Uda et al., (Kazuo Uda and Hideo Saito, “The Journal of the Society of Fiber Science and Technology, Japan”, Vol. 18, No. 1, pp. 105 to 120, 1962). Specifically, it can be determined according to the method described in JP-A-9-95538.

Further, the distribution of molecular weight of the cellulose compound of the present invention is evaluated by gel permeation chromatography. The value of the polydisperse index Mw/Mn (Mw, weight average molecular weight; and Mn, number average molecular weight) is preferably from 1.5 to 4.0, more preferably from 1.5 to 3.5, and particularly preferably from 2.0 to 3.5.

The producing method of the cellulose film of the present invention is not particularly limited, and the cellulose film can be preferably produced by a melt-casting film formation method or a solution-casting film formation method.

(Melt-Casting Film Formation)

Hereinafter, a preferred embodiment of the melt-casting film formation method of the cellulose film according to the present invention will be described.

The cellulose film according to the present invention is composed of a composition containing the cellulose compound represented by Formula (I) in an amount of preferably 20 mass % or more, more preferably 50 mass % or more, and most preferably 80 mass % or more. In the present invention, one kind of the cellulose compound may be used singly, or two or more kinds of the cellulose compound may be used as mixture. Alternatively, polymeric components other than the cellulose compound according to the present invention and various additives may be added as needed. The components added as needed are preferably those having excellent compatibility with the cellulose compound of the present invention and giving a film having transmittance of preferably 80% or more, more preferably 90% or more, and particularly preferably 92% or more.

The melt viscosity at 230° C. of the cellulose compound composition used in the melt-casting film formation (melt viscosity of the resulting cellulose film at 230° C.) is preferably 150 Pa·s to 1,000 Pa·s. Such a melt viscosity is obtained by adjusting the ratio of the substituents in the range specified by the present invention and controlling the molecular weight of the cellulose compound. An excessively high molecular weight outside the preferable range results in excessive increase in the melt viscosity, whereby prohibiting the film formation in some cases. On the other hand, a polymerization degree smaller than the preferable range leads to drastic deterioration in film strength and also in the melt viscosity, whereby resulting in insufficient kneading because of the reduced shearing force during kneading in some cases.

To the cellulose compound of the present invention, any of various additives that can be generally added to cellulose acylate (for example, a ultraviolet absorber, a plasticizer, a deterioration preventing agent, fine particles, and an optical-characteristic controlling agent) may be added, to give a composition. As to the timing at which the various additives are added to the cellulose compound represented by formula (I), the additives may be added in any of the dope production steps. They may be added in the last step (as a control step) of the dope preparation steps.

The additive(s) may be in a solid or oily state. That is, there is no particular limitation to the melting points or boiling points of the additives. For example, an ultraviolet absorber having a melting point of less than 20° C. and an ultraviolet absorber having a melting point of 20° C. or more may be used in combination; or, similarly, plasticizers may be used in combination. Specifically, the method described in JP-A-2001-151901 can be applied to the present invention.

(Stabilizer)

In the present invention, addition of a stabilizer is effective, for preservation of the stability of the cellulose compound during high-temperature melt-casting formation method. In particular, it is preferable that at least one phenol-based stabilizer having a molecular weight of 500 or more and at least one compound selected from the group consisting of phosphite-based stabilizers and thioether-based stabilizers each having a molecular weight of 500 or more, are added to the cellulose compound of the present invention. Any known phenol-based stabilizer may be used preferably as the phenol-based stabilizer. Preferred examples of the phenol-based stabilizers include hindered phenol-based stabilizers. In particular, the stabilizer preferably has a substituent at the position adjacent to the phenolic hydroxyl group. In this case, the substituent is preferably a substituted or unsubstituted alkyl group having 1 to 22 carbon atoms, and more preferably a methyl group, an ethyl group, a propyl group, an isopropyl group, a butyl group, an isobutyl group, a t-butyl group, a pentyl group, an isopentyl group, a t-pentyl group, a hexyl group, an octyl group, an isooctyl group or a 2-ethylhexyl group. In addition, stabilizers having a phenol group and a phosphite group in the same molecule are also preferable as the raw materials.

These compounds are commercially available. Examples of the commercially available products include Irganox 1076, Irganox 1010, Irganox 3113, Irganox 245, Irganox 1135, Irganox 1330, Irganox 259, Irganox 565, Irganox 1035, Irganox 1098, and Irganox 1425WL (trade names, manufactured by Ciba Specialty Chemicals); ADK STAB AO-50, ADK STAB AO-60, ADK STAB AO-20, ADK STAB AO-70, and ADK STAB AO-80 (trade names, manufactured by ADEKA corporation); SUMILIZER BP-76, SUMILIZER BP-101, and SUMILIZER GA-80 (trade names, manufactured by Sumitomo Chemical Co. Ltd.); and SEENOX 326 M and SEENOX 336B (trade names, manufactured by SHIPRO KASEI KAISHA, LTD.).

Also, it is preferable to add a phosphite-based stabilizer having a molecular weight of 500 or more and giving antioxidant effect. Specific examples of these compounds include compounds as described in the paragraph Nos. [0023] to [0039] of JP-A-2004-182979, JP-A-51-70316, JP-A-10-306175, JP-A-57-78431, JP-A-54-157159, and JP-A-55-13765. In addition, other stabilizers, such as those selected from the substances described in detail in “Hatsumei Kyokai Kokai Gihou” (Journal of Technical Disclosure) (Kogi No. 2001-1745, Mar. 15, 2001, Japan Institute of Invention and Innovation), p. 17 to 22, may be added. These substances are commercially available as ADK STAB 1178, ADK STAB 2112, ADK STAB PEP-8, ADK STAB PEP-24G, ADK STAB PEP-36G, and ADK STAB HP-10 (trade name, manufactured by ADEKA CORPORATION) and Sandostab P-EPQ (trade name, manufactured by Clariant).

Any known thioether-based stabilizer may be used as the thioether-based stabilizer. Examples of commercially available compounds include SUMILIZER TPL, SUMILIZER TPM, SUMILIZER TPS, and SUMILIZER TDP (trade names, manufactured by Sumitomo Chemical Co. Ltd.); and ADK STAB AO-412S (trade name, manufactured by ADK CORPORATION). In using these stabilizers, the at least one phenol-based stabilizer and the at least one compound selected from the group consisting of phosphite-based stabilizers and thioether-based stabilizers each are preferably contained in an amount of 0.02 to 3 mass %, particularly preferably 0.05 to 1 mass %, with respect to the cellulose acylate. The content ratio of the phenol-based stabilizer to the phosphite-based or thioether-based stabilizer is not particularly limited, but it is preferably 1/10 to 10/1 (parts by mass), more preferably 1/5 to 5/1 (parts by mass), further preferably 1/3 to 3/1 (parts by mass), and particularly preferably 1/3 to 2/1 (parts by mass).

Further, in the present invention, a stabilizer having a phenol group and a phosphite group in the same molecule is also preferable. Such raw materials are described in JP-A-10-273494. Examples of commercially available products include SUMILIZER GP (trade name, manufactured by Sumitomo Chemical Co. Ltd.). Also, usable are the long chain aliphatic amines described in JP-A-61-63686, the sterically hindered amine group-containing compounds described in JP-A-6-329830, the hindered piperidinyl-based photostabilizers described in JP-A-7-90270, the organic amines described in JP-A-7-278164, and the like. Preferred amine-based stabilizers are available commercially, as ADK STAB LA-57, ADK STAB LA-52, ADK STAB LA-67, ADK STAB LA-62, and ADK STAB LA-77 (trade names, manufactured by ADK CORPORATION); and TINUVIN 765 and TINUVIN 144 (trade names, manufactured by Ciba Specialty Chemicals). The use ratio of the amine-based stabilizer to the phosphites is generally from approximately 0.01 to 25 mass %.

<Plasticizer>

It is possible to lower the crystalline melting temperature (Tm) of the cellulose acylate, by adding a plasticizer to the melted cellulose acylate. The molecular weight of the plasticizer that can be used in the present invention is not particularly limited, but a high-molecular weight compound is preferable (for example, the molecular weigh is preferably 500 or more, more preferably 550 or more, and further preferably 600 or more). Examples of the plasticizer include phosphates, alkyl phthalyl alkyl glycolates, carboxylates, and fatty acid esters of a polyhydric alcohol. The form of the plasticizer may be in a solid state or oily state. In other words, the plasticizer is not particularly limited by its melting point or boiling point. For melt-casting film formation, a nonvolatile plasticizer can be particularly preferably used. Specific examples of the phosphates include triphenyl phosphate, tricresyl phosphate, and phenyl diphenyl phosphate.

Examples of the alkyl phthalyl alkyl glycolates include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, and octyl phthalyl ethyl glycolate.

Examples of the carboxylates include phthalates, e.g. dimethyl phthalate, diethyl phthalate, dibutyl phthalate, dioctyl phthalate, and diethylhexyl phthalate; and citrates, e.g. acetyltrimethyl citrate, acetyltriethyl citrate, and acetyltributyl citrate. Further, other than those as described above, e.g. butyl oleate, methylacetyl linoleate, dibutyl sebacate, and triacetin, may be used singly or as a mixture thereof.

The amount to be added of the plasticizer is preferably 0 to 15 mass %, more preferably 0 to 10 mass %, and particularly preferably 0 to 8 mass %, to the cellulose acylate to be used for the melt-casting film formation. The plasticizer may be added singly or in combination of two or more thereof, according to the need.

(Ultraviolet Absorber)

To the cellulose compound used for the melt-casting film formation, an ultraviolet absorber may be added. As the ultraviolet absorber, there are descriptions in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173. The amount of the ultraviolet absorber to be added is preferably 0.01 to 2 mass %, more preferably 0.01 to 1.5 mass %, to the melt-cast material (melt) to be prepared.

Examples of these ultraviolet absorbers commercially available include benzotriazole-based UV absorbers such as TINUBIN P (trade name, manufactured by Ciba Specialty Chemicals), TINUBIN 234 (trade name, manufactured by Ciba Specialty Chemicals), TINUBIN 320 (trade name, manufactured by Ciba Specialty Chemicals), TINUBIN 326 (trade name, manufactured by Ciba Specialty Chemicals), TINUBIN 327 (trade name, manufactured by Ciba Specialty Chemicals), TINUBIN 328 (trade name, manufactured by Ciba Specialty Chemicals), SUMISORB 340 (trade name, manufactured by Sumitomo Chemical Co., Ltd.), and ADK STAB LA-31 (trade name, manufactured by ADK CORPORATION); benzophenone-based ultraviolet absorbers, such as SEESORB 100 (trade name, manufactured by SHIPRO KASEI KAISHA, LTD.), SEESORB 101 (trade name, manufactured by SHIPRO KASEI KAISHA, LTD.), SEESORB 101S (trade name, manufactured by SHIPRO KASEI KAISHA, LTD.), SEESORB 102 (trade name, manufactured by SHIPRO KASEI KAISHA, LTD.), SEESORB 103 (trade name, manufactured by SHIPRO KASEI KAISHA, LTD.), ADK STAB LA-51 (trade name, manufactured by ADK CORPORATION), KEMISORB 111 (trade name, manufactured by Chemipro Kasei), and UVINUL D-49 (trade name, manufactured by BASF); oxalic acid anilide-based ultraviolet absorbers, such as TINUBIN 312 (trade name, manufactured by Ciba Specialty Chemicals) and TINUBIN 315 (trade name, manufactured by Ciba Specialty Chemicals); salicylic acid-based ultraviolet absorbers, such as SEESORB 201 (trade name, manufactured by SHIPRO KASEI KAISHA, LTD.) and SEESORB 202 (trade name, manufactured by SHIPRO KASEI KAISHA, LTD.); and cyanoacrylate-based ultraviolet absorbers, such as SEESORB 501 (trade name, manufactured by SHIPRO KASEI KAISHA, LTD.) and UVINUL N-539 (trade name, manufactured by BASF).

(Fine Particles)

In the present invention, fine particles are preferably added to the cellulose acylate composition used in the melt-casting film formation.

In the present invention, examples of the fine particles include both inorganic and organic compound fine particles, and only one or both of them may be used. In the present invention, the average primary particle size of the fine particles contained in the cellulose compound is preferably 5 nm to 3 μm, more preferably 5 nm to 2.5 μm, and particularly preferably 20 nm to 2.0 μm. The addition amount of the fine particles is preferably 0.005 to 1.0 mass %, more preferably 0.01 to 0.8 mass %, and particularly preferably 0.02 to 0.4 mass %, with respect to cellulose acylate. In the present specification, the “average primary particle size” means the particle size (diameter) of fine particles in the dispersion state (non-aggregation state), and the average primary particle size can be determined by a known method such as dynamic light scattering method (several nm to 1 μm), laser diffraction method (0.1 μm to thousands of μm), or Mie theory-based laser diffraction-scattering method (dozens nm to 1 μm).

Preferred examples of the inorganic fine particles include SiO₂, ZnO, TiO₂, SnO₂, Al₂O₃, ZrO₂, 1n₂O₃, MgO, BaO, MoO₂, V₂O₅, talc, clay, calcined kaolin, calcined calcium silicate, hydrated calcium silicate, aluminum silicate, magnesium silicate, and calcium phosphate. Among these, SiO₂, ZnO, TiO₂, SnO₂, Al₂O₃, ZrO₂, 1n₂O₃, MgO, BaO, MoO₂ and V₂O₅ are preferable; and SiO₂, TiO₂, SnO₂, Al₂O₃ and ZrO₂ are more preferable.

Examples of commercially available fine particles of SiO₂ include Aerosil R972, R972V, R974, R812, 200, 200V, 300, R202, OX50, and TT600 (trade names, manufactured by Nippon Aerosil Co., Ltd.). Examples of commercially available fine particles of ZrO₂ include Aerosil R976 and R811 (trade names, manufactured by Nippon Aerosil Co., Ltd.). Also, used may be SEAHOSTAR KE-E10, SEAHOSTAR KE-E30, SEAHOSTAR KE-E40, SEAHOSTAR KE-E50, SEAHOSTAR KE-E70, SEAHOSTAR KE-E150, SEAHOSTAR KE-W10, SEAHOSTAR KE-W30, SEAHOSTAR KE-W50, SEAHOSTAR KE-P10, SEAHOSTAR KE-P30, SEAHOSTAR KE-P50, SEAHOSTAR KE-P100, SEAHOSTAR.KE-P150, and SEAHOSTAR KE-P250 (trade names, manufactured by Nippon Shokubai Co., Ltd.). In addition, silica microbeads P-400 and 700 (trade names, manufactured by Catalysts & Chemicals Industries Co., Ltd.) can also be used. SO-G1, SO-G2, SO-G3, SO-G4, SO-G5, SO-G6, SO-E1, SO-E2, SO-E3, SO-E4, SO-E5, SO-E6, SO-C1, SO-C2, SO-C3, SO-C4, SO-C5, and SO-C6, (trade names, manufactured by Admatechs Corporation Limited) can also be used. Further, silica particles (pulverized from aqueous dispersion) manufactured by Moritex Corporation, such as Silica Particle 8050, Silica Particle 8070, Silica Particle 8100, and Silica Particle 8150 (trade names), can also be used.

Preferred examples of the organic compound fine particles include polymers, such as silicone resins, fluorine resins and acrylic resins; and particularly preferred examples are silicone resins. The silicone resin is preferably a resin having a three-dimensional network structure, and commercially available products such as Tospearl 103, Tospearl 105, Tospearl 108, Tospearl 120, Tospearl 145, Tospearl 3120 and Tospearl 240 (trade names, manufactured by Toshiba Silicone Co., Ltd.) can be used.

The inorganic compound fine particles are preferably surface-treated for stabilization thereof in the cellulose composition and film. The inorganic fine particles are also used preferably after completion of a surface-treatment. Examples of the surface-treatment include a chemical surface-treatment using a coupling agent, a physical surface-treatment such as a plasma discharge treatment and a corona discharge treatment. In the present invention, the chemical surface-treatment using a coupling agent is preferable. Preferred examples of the coupling agent include organoalkoxymetal compounds (such as silane coupling agents and titanium coupling agents). When inorganic fine particles are used as the fine particles (especially when SiO₂ is used), a treatment using a silane coupling agent is particularly effective. An organosilane compound can be used as the silane coupling agent. The amount of the silane coupling agent to be used is not particularly limited, but it is preferably 0.005 to 5 mass %, more preferably 0.01 to 3 mass %, with respect to the inorganic fine particles.

The fine particles may be added to the cellulose compound in any step of film forming. Among the steps for producing the cellulose acylate, it is also preferable to add the fine particles in a step before reprecipitation, and then to allow reprecipitation of the cellulose compound in the state containing the fine particles.

(Releasing Agent)

The cellulose composition for use in melt-casting film formation preferably contains a fluorine atom-containing compound. The fluorine atom-containing compound has a function as a releasing agent, and may be a low-molecular-weight compound or a polymer. Examples of the polymer include the polymers described in JP-A-2001-269564. The fluorine atom-containing polymer is preferably a polymer obtained by polymerizing monomers containing an ethylenically unsaturated monomer having a fluorinated alkyl group as an essential component. The fluorinated alkyl group-containing ethylenically unsaturated monomer for obtaining the polymer is not particularly limited, so far as it is a compound having an ethylenically unsaturated group and a fluorinated alkyl group in the molecule. In addition, fluorine atom-containing surfactants are also usable, and in particular, nonionic surfactants are preferable.

(Pelletization)

The cellulose compound and the additives are preferably mixed and pelletized, before the melt-casting film formation.

The pelletized mixture can be prepared by melting the cellulose compound and the additives in a biaxial or uniaxial kneading extruder at a temperature of from 150° C. to 250° C., extruding it into a noodle-shape, solidifying it in water, and cutting the resultant. The pelletization may be performed by under-water cutting method in which the cutting is carried out while directly extruding the mixture into water. Preferably, the kneading extruder for use is a ventilated type, and the pelletization is performed under reduced pressure. The pelletization is more preferably performed while the inside of the kneading extruder is substituted with nitrogen.

As for the preferable size of the pellets, it is preferable that the sectional area thereof is from 1 mm² to 300 mm², and the length thereof is from 1 mm to 30 mm; and it is more preferably that the sectional area is from 2 mm² to 100 mm² and the length is from 1.5 mm to 10 mm. The rotational frequency of the extruder is preferably from 10 to 1,000 rpm, more preferably from 30 rpm to 500 rpm. The retention time for extruding during pelletization is preferably from 10 seconds to 30 minutes, more preferably 30 seconds to 3 minutes.

(Specific Method of Melt-Casting Film Formation)

Hereinafter, a specific method of the melt-casting film formation will be described.

(1) Drying

Water in the pellets is preferably removed by drying before the melt-casting film formation. The water content is preferably 0.1 mass % or less, more preferably 0.01 mass % or less.

(2) Melt Extrusion

The dried cellulose resin is supplied through the inlet of an extruder into its cylinder.

The screw compression ratio of the extruder is preferably from 2.5 to 4.5, more preferably from 3.0 to 4.0. The ratio of L/D (in which L represents the screw length, and D represents the screw diameter) is preferably from 20 to 70, more preferably from 24 to 50. The melting temperature is preferably the temperature described above.

For prevention of oxidation of the resin, it is preferable that the inside of the extruder is substituted with the stream of an inactive gas (such as nitrogen) or a ventilated extruder is used under vacuum evacuation.

(3) Filtration

The resin is preferably filtered through a breaker plate at the outlet of the extruder.

For high-precision filtration, it is preferable that the extruded material passes through a filtration device containing a leaf-shaped disk filter after passing through a gear pump. The filtration may be performed in a single step or in multiple steps.

(4) Gear Pump

For improvement in the accuracy of thickness (for prevention of fluctuation in discharge rate), it is preferable to install a gear pump between the extruder and a dice. It is also preferable to reduce the fluctuation of the temperature of adapters connecting, for example, the extruder to the gear pump or the gear pump to the die, for stabilization of the extrusion pressure.

(5) Die

Any conventional T die, fishtail die or hangercoat die can be used, so far as the retention time of the melted resin in the die is short. Alternatively, a static mixer immediately before the T die is also preferably installed for improvement in evenness of the resin temperature.

The retention time of the resin moving through the extruder from the inlet to the dice is preferably from 2 to 60 minutes, more preferably from 4 to 30 minutes.

(6) Casting

The melt resin extruded out of the die onto a sheet is cooled on a casting drum(s), to give a film. At this time, a touch roll is preferably used.

For gradual cooling, it is preferable to use 1 to 8 casting drums, more preferably 2 to 5 casting drums. And then, the film is separated from the casting drum(s), treated with a nip roll, and then wound. The thus-obtained unstretched film has a thickness of preferably from 30 μm to 400 μm, more preferably from 50 μm to 200 μm.

(7) Winding

The film is preferably trimmed at both ends before winding. The trimmed region may be reused as a film raw material. The winding tension may be constant during winding. However, it is more preferable that the film is wound by using taper according to the winding diameter. Alternatively, by adjusting the draw ratio between nip rolls, it is also possible to prevent in-line application of excessive tension on the film.

A laminate film may be additionally provided with at least one side of the film before winding.

The amount of the residual organic solvent in the cellulose film according to the present invention is preferably 0.03 mass % or less, more preferably. 0.02% or less, and particularly preferably 0.01% or less. When the amount of the residual solvent is in the range above, it is possible to prevent generation of the odor of the solvent and change in film properties caused by vaporization of the solvent, which is preferable. The melt-casting film formation method is a method effective in reducing the residual solvent amount.

The amount of the residual solvent can be determined, for example, by gas chromatographic method.

<Solution-Casting Film Formation>

Hereinafter, a preferable embodiment of the method of producing the cellulose compound according to the present invention by solution-casting film formation method will be described. In the present invention, the solvent for the cellulose compound is not particularly limited, so far as the cellulose compound dissolves therein, the obtained solution can be cast into film, and the object of the present invention is achieved. Preferred examples of the solvent include a chlorine-based organic solvent, such as dichloromethane, chloroform, 1,2-dichloroethane, and tetrachloroethylene; and a non-chlorine-based organic solvent.

Preferred examples of the non-chlorine-based organic solvent that can be used in the present invention include an ester, a ketone, and an ether, each having 3 to 12 carbon atoms. The ester, ketone, or ether may have a cyclic structure. A compound having two or more functional groups of ester, ketone or ether (—O—, —CO— or —COO—) is also usable as a main solvent. The solvent may have other functional groups such as alcoholic hydroxyl group. When the main solvent is solvent having two or more functional groups, the number of carbon atoms in the solvent is preferable in any of the above range. Examples of the ester having 3 to 12 carbon atoms include ethyl formate, propyl formate, pentyl formate, methyl acetate, ethyl acetate, and pentyl acetate. Examples of the ketone having 3 to 12 carbon atoms include acetone, methylethyl ketone, diethyl ketone, diisobutyl ketone, cyclopentanone, cyclohexanone and methylcyclohexanone. Examples of the ether having 3 to 12 carbon atoms include diisopropyl ether, dimethoxymethane, dimethoxyethane, 1,4-dioxane, 1,3-dioxolan, tetrahydrofuran, anisole and phenetole. Examples of the organic solvent having two or more functional groups include 2-ethoxyethyl acetate, 2-methoxyethanol and 2-butoxyethanol.

The chlorine-based organic solvent that can be used in the present invention is not particularly limited, so far as the cellulose compound dissolves therein, the obtained solution can be cast into film, and the object of the invention is achieved. The chlorine-based organic solvent is preferably dichloromethane or chloroform. Dichloromethane is particularly preferable. Any organic solvent other than the chlorine-based organic solvent may be used in combination with the chlorine-based organic solvent. In this case, it is necessary to use the chlorine-based organic solvent, such as dichloromethane, at a proportion of at least 50 mass %. A non-chloride-based organic solvent that can be used in combination with the chlorine-based organic solvent is described below. Preferred examples of the non-chloride-based organic solvent that can be used in combination include an ester, a ketone, an ether, an alcohol, and a hydrocarbon, each having 3 to 12 carbon atoms. The ester, ketone, ether, or alcohol may have a cyclic structure. A compound having two or more functional groups of ester, ketone or ether (—O—, —CO— or —COO—) is also usable as the solvent. The organic solvent may have other functional groups such as alcoholic hydroxyl group. When the solvent is the compound having two or more functional groups, the number of carbon atoms is preferable in any of the above range. Examples of the ester having 3 to 12 carbon atoms include ethyl formate, propyl formate,-pentyl formate, methyl acetate, ethyl acetate, and pentyl acetate. Examples of the ketone having 3 to 12 carbon atoms include acetone, methylethyl ketone, diethyl ketone, diisobutyl ketone, cyclopentanone, cyclohexanone and methylcyclohexanone. Examples of the ether having 3 to 12 carbon atoms include diisopropyl ether, dimethoxymethane, dimethoxyethane, 1,4-dioxane, 1,3-dioxolan, tetrahydrofuran, anisole and phenetole. Examples of the organic solvent having two or more functional groups include 2-ethoxyethyl acetate, 2-methoxyethanol and 2-butoxyethanol.

The alcohol that can be used with the chlorine-based organic solvent may be in a straight, branched, or cyclic form. In particular, it is preferably an alcohol derived from a saturated aliphatic hydrocarbon. The alcohol may be any one of primary, secondary, and tertiary alcohols. Examples of the alcohol include methanol, ethanol, 1-propanol, 2-propanol, 1-butanol, 2-butanol, t-butanol, 1-pentanol, 2-methyl-2-butanol, and cyclohexanol. The alcohol may be a fluorinated alcohol, e.g., 2-fluoroethanol, 2,2,2-trifluoroethanol, and 2,2,3,3-tetrafluoro-1-propanol.

The hydrocarbon may be in a straight, branched, or cyclic form. The hydrocarbon may be an aromatic hydrocarbon or an aliphatic hydrocarbon. The aliphatic hydrocarbon may be saturated or unsaturated. Examples of the hydrocarbon include cyclohexane, hexane, benzene, toluene, and xylene.

The non-chlorine-based organic solvent which is used together with the chlorine-based organic solvent as a main solvent for the cellulose compound is not particularly limited, but may be preferably selected from methyl acetate, ethyl acetate, methyl formate, ethyl formate, acetone, dioxolane, dioxane, ketones and acetoacetates each having 4 to 7 carbon atoms, and alcohols and hydrocarbons each having 1 to 10 carbon atoms. Preferable examples of the non-chlorine-based organic solvent that can be used in combination include methyl acetate, acetone, methyl formate, ethyl formate, methyl ethyl ketone, cyclopentanone, cyclohexanone, methyl acetylacetate, methanol, ethanol, 1-propanol, 2-propanol, 1-butanol, 2-butanol, cyclohexanol, cyclohexane, and hexane.

It is preferable that the cellulose compound of the present invention is in a form of a solution in which the cellulose compound is dissolved in an organic solvent at a concentration of from 10 to 35 mass %, more preferably from 13 to 30 mass %, and particularly preferably from 15 to 28 mass %. The cellulose compound concentration may be controlled to such a range, by controlling the concentration at the dissolution step. Alternatively, it is also possible that a solution of a low concentration (for example, from 9 to 14 mass %) is preliminarily prepared and then the concentration is controlled to the aforementioned range in the subsequent concentrating step as will be described hereinafter. It is also possible that a cellulose compound solution of a high concentration is preliminarily prepared and then various additives are added, to give a cellulose compound solution of a lowered concentration as mentioned in the above. Any method may be used without any problem so long as the cellulose compound solution of the aforementioned concentration can be attained.

In the preparation of a cellulose compound solution (dope) according to the present invention, there is no particular restriction on dissolution method. Namely, the dope may be prepared at room temperature, or by a chilling dissolving method or a high-temperature dissolving method, or a combination of these methods. Methods of preparing the cellulose acylate solution are described in, for example, JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017, and JP-A-11-302388. The above-described methods of dissolving a cellulose acylate in an organic solvent can be properly applied to the present invention as long as they do not exceed the scope of the present invention. These techniques can be carried out, in particular for a system utilizing a non-chlorine-based solvent, in accordance with the method described in detail in Japan Institute of Invention and Innovation Journal of Technical Disclosure No. 2001-1745 (Mar. 15, 2001, Japan Institute of Invention and Innovation), pages 22 to 25. Further, the solution of the cellulose compound according to the present invention is usually concentrated and filtered, as described in detail in Japan Institute of Invention and Innovation Journal of Technical Disclosure No. 2001-1745 (Mar. 15, 2001, Japan Institute of Invention and Innovation), p. 25. In high-temperature dissolution, a temperature not lower than the boiling point of the organic solvent to be employed is used in most cases, and the dissolution is performed under pressurized condition in such cases.

In the present invention, the cellulose compound solution preferably has viscosity and dynamic storage modulus in certain ranges. These values are measured in the following manner: 1 mL of a sample solution is subjected to a rheometer (trade name: CLS 500, manufactured by TA Instruments) using a Steel Cone (trade name, manufactured by TA Instruments) having a diameter of 4 cm/2° to measure its viscosity and storage modulus. Measurement conditions are Oscillation Step/Temperature Ramp in the range of 40° C. to −10° C. changing at 2° C./minute, and the static non-Newtonian viscosity n* (Pa·s) at 40° C. and the storage modulus G′(Pa) at −5° C. are determined. After the sample solution is heated to a measurement starting temperature and maintained at that temperature to give a constant solution temperature, measurement is then started. In the present invention, the viscosity at 40° C. is preferably 1 to 400 Pa·s, the dynamic storage modulus at 15° C. is preferably 500 Pa or greater, the viscosity at 40° C. is more preferably 10 to 200 Pa·s, and the dynamic storage modulus at 15° C. is more preferably 100 to 1,000,000 Pa. The higher the dynamic storage modulus at low temperature, the more preferable it is, and, for example, in a case in which the temperature of a casting support is at −5° C., the dynamic storage modulus at −5° C. is preferably 10,000 to 1,000,000 Pa, and in a case in which the temperature of the support is at −50° C., the dynamic storage modulus at −50° C. is preferably 10,000 to 5,000,000 Pa.

(Specific Method of Solution Casting Film Formation)

Hereinafter, the method of producing the cellulose film according to the present invention will be described. As a method and equipment for producing the cellulose film of the present invention, generally employed are a solution cast film formation method and solution cast film formation equipment that are conventionally employed for production of a cellulose acylate film. A dope (a cellulose compound solution) prepared in a dissolution machine (pot) is once stored in a storage pot, and, after defoaming to remove the foams in the dope, the dope is subjected to the final preparation. The dope is discharged from a dope exhaust and fed into a pressure die via, for example, a pressure constant-rate gear pump whereby the dope can be fed at a constant flow rate at a high accuracy depending on a rotational speed. From a pipe sleeve (slit) of the pressure die, the dope is uniformly cast onto a metallic support continuously running in the casting section. At the peeling point where the metallic support has almost rounded in one cycle, the half-dried dope film (also called a web) is peeled from the metallic support. The obtained web is clipped at both ends and dried by conveying with a tenter while maintaining the width at a constant level. Subsequently, the thus-obtained web film is mechanically conveyed with rolls in a dryer, to complete the drying, followed by winding with a winder into a rolled shape in a given length. Combination of the tenter and rolls in the dryer may vary depending on the purpose. In the solution cast film-forming method utilized to produce a silver halide photographic light-sensitive material or a functional protective film for electronic displays, a coater is additionally employed in many cases, in addition to the solution cast film-forming apparatus, so as to treat the film surface by providing, for example, an undercoat layer, an antistatic layer, an anti-halation layer or a protective layer. These production steps are described in detail in “Hatsumei Kyokai Kokai Giho” (Journal of Technical Disclosure) (Kogi No. 2001-1745, published Mar. 15, 2001, Japan Institute of Invention and Innovation), pp. 25 to 30, and they are classified into casting (including co-casting), metal supports, drying, releasing (peeling), stretching, and the like.

In the present invention, the space temperature of the casting section is not particularly limited, but it is preferably −50° C. to 50° C., more preferably −30° C. to 40° C., and particularly preferably −20° C. to 30° C. In particular, a cellulose compound solution that is cast at a low space temperature is instantaneously cooled on the support, thus increasing the gel strength and thereby holding the film, which contains an organic solvent. By so doing, it is possible to peel the cellulose film from the support in a short time, without evaporating the organic solvent from the cellulose compound, thus enabling high speed casting to be achieved. With regard to means for cooling space, normal air, nitrogen, argon, helium, etc. may be employed, and the means is not particularly limited. In this case, the relative humidity is preferably 0% RH to 70% RH, and more preferably 0% RH to 50% RH. Further, in the present invention, the temperature of the support of the casting section, in which the cellulose compound solution is to be cast, is generally −50° C. to 130° C., preferably −30° C. to 25° C., and more preferably −20° C. to 15° C. To maintain the casting section at the temperature preferable in the present invention, a cooled gas may be introduced to the casting section, or a cooling device may be disposed in the casting section so as to cool the space. In this arrangement, it is important that attention is paid to preventing water from becoming attached, and this can be achieved by a method utilizing a dried gas.

Particularly preferred contents and casting of each layer in the present invention are as follows. That is, the cellulose compound solution contains, at 25° C., at least one kind of liquid or solid plasticizer in an amount of from 0.1 to 20 mass % to the cellulose compound, and/or at least one kind of liquid or solid ultraviolet absorbing agent in an amount of from 0.001 to 5 mass % to the cellulose compound, and/or at least one kind of solid fine-particulate powder having an average particle diameter of 5 to 3,000 nm in an amount of from 0.001 to 5 mass % to the cellulose compound, and/or at least one kind of fluorine-containing surfactant in an amount of from 0.001 to 2 mass % to the cellulose compound, and/or at least one kind of peeling agent in an amount of from 0.0001 to 2 mass % to the cellulose compound, and/or at least one kind of degradation inhibitor in an amount of from 0.0001 to 2 mass % to the cellulose compound, and/or at least one kind of optical anisotropy control agent in an amount of from 0.1 to 15 mass % to the cellulose compound, and/or at least one kind of infrared absorbing agent in an amount of from 0.1 to 5 mass % to the cellulose compound, and a cellulose film prepared using the cellulose compound solution above.

In the casting step, a single kind of a cellulose compound solution may be cast to form a monolayer, or two or more kinds of cellulose compound solutions may be simultaneously or sequentially cocast. When two or more layers are formed in the casting step, the cellulose compound solutions and the cellulose film that are to be prepared from said solutions, are preferably provided in such a manner that: the chlorine-containing solvents in the respective layers have either the same or different compositions; the respective layers contain either a single kind of additive or a mixture of two or more kinds of additives; the additives are placed in either the same or different layers; the solutions of the additive for the respective layers have either the same or different concentrations; aggregates or associations in the respective layers have either the same or different molecular weights; the solutions for the respective layers have either the same or different temperatures; the respective layers are either the same or different in coated amounts; the respective layers have either the same or different viscosities; the respective-layers have either the same or different film thicknesses after drying; the states or distributions of a material present in the respective layers are either the same or different; the respective layers have either the same or different physical properties; or the respective layers have either uniform physical properties or different physical properties distributed between the layers. The physical properties referred to here include physical properties described in detail in “Hatsumei Kyokai Koukai Giho (Journal of Technical Disclosure)” (Technical Disclosure No. 2001-1745, published Mar. 15, 2001, Japan Institute of Invention and Innovation), pp. 6 to 7, and examples thereof include haze, transmittance, spectroscopic characteristics, retardation Re, retardation Rth, molecular orientation axis, axial displacement, tear strength, bending strength, tensile strength, difference in Rt between inner and outer windings, creaking, dynamic friction, alkaline hydrolysis, curl value, water content, amount of residual solvent, thermal shrinkage, high humidity dimensional evaluation, water vapor permeability, base planarity, dimensional stability, thermal shrinkage starting temperature, modulus of elasticity, and bright point foreign matter and, furthermore, impedance and surface condition used for the evaluation of a base. Moreover, there are also included yellow index, transparency, and thermophysical properties (Tg, heat of crystallization) of the cellulose compound, these being described in detail in “Hatsumei Kyokai Koukai Giho (Journal of Technical Disclosure)” (Technical Disclosure No. 2001-1745, published Mar. 15, 2001, Japan Institute of Invention and Innovation), p. 11.

<Treatment of Cellulose Film>

(Stretching)

It is preferable to stretch the cellulose film of the present invention prepared by the solution casting film-formation method or the melt casting film-formation method in order to improve the surface state, develop the Re and Rth, improve the coefficient of linear expansion, and the like.

The stretching may be carried out on-line in the process of film-formation or may be carried out off-line after a cellulose film is wound-up after completion of film-formation. That is to say, in the case a melt-casting film-formation method, the stretching may be carried out before the completion of cooling in the process of film-formation or after the completion of cooling.

The stretching may be carried out at temperature in the range of preferably from Tg to (Tg+50° C.), more preferably from (Tg+1° C.) to (Tg+30° C.), and most preferably from (Tg+2° C.) to (Tg+20° C.). A stretching ratio may be preferably from 0.1 to 500%, more preferably from 10 to 300%, and particularly preferably from 30 to 200%. The stretching may be carried out in a single step or multiple steps. The stretching ratio herein used is defined as described below:
Stretching ratio(%)=100×{(length after stretching)−(length before stretching)}/(length before stretching).

Such stretching may be carried out by lengthwise stretching, crosswise stretching or combination thereof. The lengthwise stretching may be carried out by the use of (1) a roll stretching method in which stretching is performed in the direction of the length by the use of two or more pairs of nip roles the peripheral speed at the outlet of which is higher, (2) a fixed-edge stretching method in which both edges of a film are grasped and transferred lengthwise at the speed gradually increased to perform the stretching in the direction of the length of film, etc. The crosswise stretching may be carried out by the use of a tenter stretching in which both edges of a film are grasped by a chuck and extended to crosswise direction (in the direction perpendicular to lengthwise direction) to perform the stretching. The lengthwise stretching and the crosswise stretching may be carried out singly (monoaxial stretching) or in combination thereof (biaxial stretching). In the case of biaxial stretching, the lengthwise stretching and the crosswise stretching may be sequentially carried out (sequential stretching) or simultaneously (simultaneous stretching).

The stretching speeds of the lengthwise stretching and the crosswise stretching are preferably from 10%/minute to 10,000%/minute, more preferably from 20%/minute to 1,000%/minute, and particularly preferably from 30%/minute to 800%/minute. In the case of multiple-step stretching, such stretching speeds refer to mean value of the stretching speed at each of steps.

Following such stretching as above described, relaxation is preferably carried out to the lengthwise direction or crosswise direction by from 0% to 10%. Further, following the stretching, heat setting is preferably carried out at temperatures in the range from 150° C. to 250° C. for time from 1 second to three minutes.

The thickness of a film stretched in such a manner as above described is preferably from 10 to 300 μm, more preferably from 20 to 200 μm, and particularly preferably from 30 to 100 μm.

An angle (θ) which the direction of film-formation (lengthwise direction) forms with a retardation axis of Re of a film is preferably as closer as possible to 0°, +90° or −90°. That is to say, in the case of lengthwise stretching, such an angle (θ) is preferably as closer as possible to 0°, more preferably (0±3)°, further more preferably (0±2)°, and particularly preferably (0±1)°; in the case of crosswise stretching, such an angle (θ) is preferably (90±3)° or (−90±3)°, more preferably (90±2)° or (−90±2)°, and particularly preferably (90±1)° or (−90±1)°.

In order to suppress light leakage when a polarizing plate is viewed from a slant direction, it is necessary to arrange the transmission axis of the polarizing film in parallel to the in-plane slow-phase axis (retardation axis) of the cellulose film. Generally, the transmission axis of a roll film-shaped polarizing film which is continuously produced, is parallel to the transverse (width) direction of the roll film. Thus, in order to apply the roll film-shaped polarizing film continuously to a protective film composed of the roll film-shaped cellulose film to make lamination of them, it is necessary that the in-plane slow-phase axis of the roll film-shaped protective film is parallel to the transverse direction of the film. Thus, it is preferable to stretch the cellulose film much in the transverse direction. Further, the stretching may be carried out in the course of the film-forming step, or a roll of raw film formed and wound may be stretched. In the former case, the film may be stretched in the condition that the film contains a residual solvent. The film can be preferably stretched when the amount of the residual solvent is 2 to 30% by mass.

The film thickness of the cellulose film that is preferably used in the present invention, obtained after drying may vary depending on the purpose of use, but it is preferably in a range of from 5 to 500 μm, more preferably 20 to 300 μm, and particularly preferably 30 to 150 μm. Further, the film thickness of the cellulose film is preferably 40 to 110 μm, when the film is applied to optical devices, particularly VA liquid crystal displays. In order to control the thickness of the film, it is sufficient to control, for example, the concentration of the solid contained in the dope, the slit gap of a die nozzle, the extrusion pressure from the die, and the speed of the metal support, to attain a target thickness.

The width of the cellulose film obtained in the above manner is preferably 0.5 to 3 m, more preferably 0.6 to 2.5 m, and further preferably 0.8 to 2.2 m. The film is wound in a length of preferably 100 to 10,000 m, more preferably 500 to 7,000 m, and further preferably 1,000 to 6,000 m, per roll. When the film is wound, at least one end of the roll is preferably knurled. The width of the knurl is preferably 3 mm to 50 mm, and more preferably 5 mm to 30 mm, and the height of the knurl is preferably 0.5 to 500 μm, and more preferably 1 to 200 μm. The film may be knurled on one side or both sides.

The above-described non-stretched or stretched cellulose film may be used singly, or may be used in combination with a polarizing plate. Alternatively, a liquid crystal layer, a refractive index-controlling layer (low reflective layer) or a hard coat layer may be bonded on them to use.

[Optical Properties of Cellulose Film]

The retardations in the present invention will be described below. In the present specification, Re and Rth (unit: nm) are determined in the following manner. First, a film is conditioned at 25° C. and a relative humidity of 60% for 24 hours, and the average refractive index (n) represented by Expression (a) is determined at 25° C. and a relative humidity of 60% by using a 532-nm solid laser and a prism coupler (MODEL 2010 Prism Coupler (trade name) manufactured by Metricon).
n=(n_{TE}×2+n_{TM})/3 Expression (a)

In Expression (a), n_{TE} is a refractive index as determined by using a polarized light in the film plane direction, and n_{TM} is a refractive index as determined by using a polarized light in the normal direction of the film surface.

Herein, in the present specification, the Re(λ) and the Rth(λ) indicate the in-plane retardation and the retardation in the direction of the thickness, respectively, at the wavelength λ (nm). The Re(λ) can be measured by making light of wavelength λ nm incident in the direction of the normal of the film, in KOBRA 21ADH or WR (each trade name, manufactured by Oji Scientific Instruments).

In the case where the film to be measured can be expressed by a uniaxial or biaxial index ellipsoid (polarizability ellipsoid), the Rth(λ) thereof is calculated as follows.

Rth(λ) is calculated using KOBRA 21ADH or WR on the basis of: the above-described Re(λ), retardation-values in total eleven directions measured by making light of wavelength λ nm incident in the normal direction and directions inclined to ±500 at an interval of 10° over the normal direction of the film with the in-plane retardation axis as an inclined axis (a rotation axis) (or with an arbitrary direction in the film plane as a rotation axis when there is no retardation axis); the estimated average refractive index; and, the input value of the film thickness.

When there is no description on λ, and the retardations are indicated only by Re and Rth as described herein, it means that the values are determined by using a light at a wavelength of 590 nm. In the above-described method, when the film has a retardation value of zero in a direction inclined to a certain degree over the normal direction with the in-plane retardation axis as a rotation axis, the retardation value in a direction inclined to a larger degree than the above-described direction is calculated by KOBRA 21 ADH or WR, after the sign of the retardation value is converted to negative.

Alternatively, Rth may also be calculated by expressions (b) and (c), on the basis of: retardation values measured from arbitrary inclined two directions, with the retardation axis as an inclined axis (a rotation axis) (or with the in-plane arbitrary direction as a rotation axis when there is no retardation axis); the estimated average refractive index; and the input value of the film thickness.

$$Re ( θ ) = [ n x - \frac{( n y \times n z )}{\sqrt{\begin{matrix}{\{ n y sin ( {sin}^{- 1} ( \frac{sin ( - θ )}{n x} ) ) \}}^{2} + \\ \{ n z {cos ( {sin}^{- 1} ( \frac{sin ( - θ )}{n x} ) )}^{2} \}\end{matrix}}} ] \times \frac{d}{cos \{ {sin}^{- 1} ( \frac{sin ( - θ )}{n x} ) \}} \qquad Formula ( b )$$

In the expression (b), Re(θ) represents a retardation value in the direction inclined by an angle θ from the normal direction, nx represents a refractive index in the retardation axis direction in the plane, ny represents a refractive index in the direction orthogonal to nx in the plane, and nz represents a refractive index in the direction orthogonal to nx and ny.

$$Rth = ( \frac{nx + ny}{2} - n z ) \times d \qquad Formula ( c )$$

In the case where the film to be measured cannot be expressed by a uniaxial or biaxial index ellipsoid, i.e. a film having no so-called optic axis, the Rth(λ) thereof is calculated as follows.

Rth(λ) is calculated using KOBRA 21ADH or WR, on the basis of: the above-described Re(λ); retardation values measured in eleven directions, by making light of wavelength λ nm incident in the directions inclined to −50° to +50° at an interval of 10° over the normal direction of the film with the in-plane retardation axis (judged by the KOBRA 21ADH or WR) as an inclined axis (a rotation axis); the estimated average refractive index; and the input value of the film thickness.

In the above measurement methods, as the estimated (hypothetical) value of the average refractive index, use may be made, for example, of values described in “Polymer Handbook” (JOHN WILEY & SONS, INC.) and values described in catalogues of various optical films. Unknown average refractive indexes may be measured to determine by an Abbe refractometer. Average refractive indexes of major optical films are exemplified in below: cellulose acylate (1.48), cycloolefin polymer (1.52), polycarbonate (1.59), polymethyl methacrylate (1.49), and polystyrene (1.59). KOBRA 21ADH or WR can calculate nx, ny, and nz, by inputting these estimated values of the average refractive index and the film thickness. From the thus-calculated nx, ny, and nz, Nz=(nx−nz)/(nx−ny) is further calculated.

In the case of an oriented film sample, Re of the cellulose film according to the present invention is a value obtained by subtracting the refractive index in the MD direction (direction orthogonal to TD direction) from the refractive index in the TD direction (orientation direction), and multiplying the difference by the thickness (i.e., Re=(nx−ny)d). Thus, a positive Re means that the refractive index in the TD direction (nx) is larger than the refractive index in the MD direction (ny).

Rth is a value obtained by subtracting the refractive index in the thickness direction from the average value of the refractive indexes in the length and width directions of the film plane (average value of the refractive indexes in the TD and MD directions in the case of the oriented film described below), and multiplying the difference by the thickness (i.e., Rth={(nx+ny)/2−nz}d). Thus, a positive Rth means that the average value of the refractive indexes in the film plane ((nx+ny)/2) is larger than the refractive index in the thickness direction (nz).

In the cellulose film according to the present invention, Re(550 nm) is preferably positive value (larger than zero (0)) in an orientation direction, and Re at particular wavelength satisfies the following Expressions (IV) and (V).
0.5<Re(450nm)/Re(550nm)<1.0 Expression (IV)
1.05<Re(630nm)/Re(550nm)<1.5 Expression (V)

For such a wavelength dispersion of optical properties, it is preferable to appropriately adjust the direction of a transition moment and absorption wavelengths in the orientation direction (hereinafter, referred to as TD direction) and the direction perpendicular to the TD direction (hereinafter, referred to as MD direction).

Re is a value obtained by subtracting the refractive index in the MD direction from the refractive index in the TD direction. Thus, when the wavelength dispersion of the refractive index in the MD direction tends downward compared with one in the TD direction (the slope, of Re when smaller wavelengths are on the left side and larger wavelengths are on the right side), the subtracted value satisfies the following expressions (IV) and (V). The wavelength dispersion of the retardation is, as represented by the Lorentz-Lorenz expression, closely related to the absorption of a substance. Thus, for allowing the wavelength dispersion in the MD direction to tend downward, when the absorption transition wavelength in the MD direction is shifted to a longer wavelength region than one in the TD direction, a film satisfying the expressions (IV) and (V) can be designed.

The dispersion (scattering) of a Re(590) value in the transverse direction of the film is preferably ±5 nm, and more preferably ±3 nm. Also, the dispersion of a Rth(590) value in the transverse direction is preferably ±10 nm, and more preferably ±5 nm. Further, each dispersion of Re value and Rth value in the longitudinal direction is preferably within the same range as to that of the dispersion in the transverse direction.

It is preferable that the Re(λ) retardation value and the Rth(λ) retardation value satisfy the following expressions (VIII) and (IX), respectively, to widen the angle of field of view of a liquid crystal display, particularly a VA or OCB mode liquid crystal display. Further, this is particularly preferable when the cellulose film is used for the protective film on the liquid crystal cell side of the polarizing plate.
0nm≦Re(590)≦200nm Expression (VIII)
0nm≦Rth(590)≦400nm Expression (IX)

In the above expressions, Re(590) and Rth(590) each are a value (unit: nm) measured at wavelength of 590 nm.

It is preferable that the Re(λ) retardation value and the Rth(λ) retardation value satisfy the following expressions (VIII-I) and (IX-I), respectively.
30nm≦Re(590)≦150nm Expression (VIII-I)
30nm≦Rth(590)≦300nm Expression (IX-I)

When the cellulose film of the present invention is used in a VA or OCB mode, there are two types of structures: a structure (two-film type) in which the film is applied to each side of a cell, i.e. the total two films are utilized; and a structure (one-film type) in which the film is applied only one side of a cell.

In the case of the two-film type, the Re(590) is preferably 20 to 100 nm, more preferably 30 to 70 nm; and the Rth(590) is preferably 70 to 300 nm, more preferably 100 to 200 nm.

In the case of the one-film type, the Re(590) is preferably 30 to 150 nm, more preferably 40 to 100 nm; and the Rth(590) is preferably 100 to 300 nm, more preferably 150 to 250 nm.

(Haze)

The cellulose film of the present invention has a haze value of preferably 0.1 to 0.8, more preferably 0.1 to 0.7, and most preferably 0.1 to 0.6, when measured using, for example, a haze meter (trade name: 1001 DP model, manufactured by Nippon Denshoku Industries Co., Ltd.). When the haze is controlled in the above-described range, a liquid crystal display device incorporating the film as an optical compensation film provides an image of high contrast.

(Elasto-Optic Factor)

The cellulose film of the present invention is preferably used for a polarizing plate protective film or a retardation film. When the cellulose film of the present invention is used for a polarizing plate protective film or a retardation film, double refraction (Re, Rth) may change by stress caused by elongation and shrinkage of a film by moisture absorption. Such change in double refraction caused by stress can be measured as an elasto-optic factor; and it is preferably from 5×10⁻⁷ to 30×10⁻⁷ cm²/kgf, more preferably from 6×10⁻⁷ to 25×10⁻⁷ cm²/kgf, and particularly preferably from 7×10⁻⁷ to 20×10⁻⁷ cm²/kgf.

(Surface Treatment)

A stretched or non-stretched cellulose film may be subjected to a surface treatment, if necessary, in order to achieve strong adhesion between the cellulose film and each functional layers (e.g., subbing layer and backing layer). For example, a glow discharge treatment, an ultraviolet ray treatment, a corona discharge treatment, a flame treatment, an acid treatment, and an alkali treatment may be applied. The glow discharge treatment referred to herein may be a treatment with low-temperature plasma (thermal plasma) generated in a low-pressure gas having a pressure of 10⁻³ to 20 Torr, or preferably with plasma under the atmospheric pressure. A plasma excitation gas is a gas which can be excited to plasma under conditions as described above, and examples thereof include argon, helium, neon, krypton, xenon, nitrogen, carbon dioxide, frons such as tetrafluoromethane, and a mixture thereof. Details thereof are described in “Kokai Gihou,” 2001-1745, published on Mar. 15, 2001, pp. 30-32. In the plasma treatment under the atmospheric pressure, to which attention has been paid in recent years, for example, a radiating energy of 20 to 500 kGy is used under a condition of 10 to 1,000 keV, and preferably a radiating energy of 20 to 300 kGy is used under a condition of 30 to 500 keV. Of these treatments, an alkali saponifying treatment is particularly preferable, which treatment is quite effective as the surface treatment for the cellulose film.

The alkali saponifying treatment may be conducted by immersing the film into a saponifying solution, or applying a saponifying solution onto the film. In the case of the immersing method, the treatment can be attained by passing the film into a tank wherein an aqueous solution of NaOH, KOH or the like which has a pH of 10 to 14 and is heated to 20 to 80° C. is put for 0.1 to 10 minutes, neutralizing the solution on the film, washing the film, and drying the film.

The application method includes dip coating, curtain coating, extrusion coating, bar coating and type E coating. As the solvent in the alkali saponifying treatment coating solution, it is preferable to employ a solvent which has an excellent wettability appropriate for applying the saponifying solution to a transparent support and can hold favorable surface conditions without forming any irregularity on the transparent support surface. More specifically speaking, it is preferable to use an alcoholic solvent, and particularly preferably isopropyl alcohol. It is also possible to employ ant aqueous solution of a surfactant as the solvent. As the alkali in the alkali saponifying solution, it is preferable to use an alkali soluble in the above-described solvent, and KOH and NaOH are more preferable. It is preferable that the pH of the saponifying coating solution is 10 or more, more preferably 12 or more. Concerning the reaction conditions, it is preferable to perform the alkali saponification at room temperature for from 1 second to 5 minutes, more preferably for from 5 seconds to 5 minutes, and particularly preferably for from 20 seconds to 3 minutes. After the completion of the alkali saponification reaction, it is preferable to wash with water; or wash with acid and then wash with water, the surface coated with the liquid saponifying solution. The solution-applying type saponifying treatment, and the application of an oriented film, which will be detailed later, may be continuously conducted. In the case, the number of steps can be reduced. These saponifying methods are specifically described in, for example, JP-A-2002-82226 and WO 02/46809.

It is preferable to form an undercoat layer on the film in order to bond the film to a functional layer. This layer may be applied onto the film after the above-mentioned surface treatment is conducted, or without conducting any surface treatment. Details of the undercoat layer are described in “Hatsumei Kyokai Kokai Gihou” (Journal of Technical Disclosure) (Kogi No. 2001-1745, Mar. 15, 2001, Japan Institute of Invention and Innovation), p. 32.

The surface treatment, and the undercoating step may be integrated, as a final stage, into the film forming process, or may be carried out independently or in the middle of the step of forming the functional layer, which will be detailed just below.

(Incorporation of Functional Layer)

It is preferable to combine the cellulose film of the present invention with one or more of the functional layers details of which are described in “Hatsumei Kyokai Kokai Gihou” (Journal of Technical Disclosure) (Kogi No. 2001-1745, Mar. 15, 2001, Japan Institute of Invention and Innovation); pp. 32-45. Of these functional layers, preferable are a polarizing layer, which is used to form a polarizing plate, an optical compensation layer, which is used to form an optical compensation sheet, and an antireflection layer, which is used to an antireflection film.

[Polarizing Layer]

(Material to be Used of Polarizing Layer)

At present, a commercially available polarizing film (layer) is generally formed by immersing a stretched polymer into a solution of iodine or a dichroic dye in a bath, thereby causing the iodine or dichroic dye to permeate the binder. As the polarizing film, a coating type polarizing film, typical examples of which are manufactured by Optiva Inc., can also be used.

The iodine or the dichroic dye in the polarizing film is oriented in the binder, thereby exhibiting polarizing performance. Examples of the dichroic dye include azo-series dyes, stilbene-series dyes, pyrazolone-series dyes, triphenylmethane-series dyes, quinoline-series dyes, oxazine-series dyes, thiazine-series dyes and anthraquinone-series dyes. Of these dyes, water-soluble dyes are preferred. The dichroic dyes preferably contain hydrophilic substituent, such as sulfonic acid, amino and hydroxyl groups. Examples thereof include compounds described in “Hatsumei Kyokai Kokai Gihou” (Journal of Technical Disclosure) (Kogi No. 2001-1745, Mar. 15, 2001, Japan Institute of Invention and Innovation), p. 58.

The binders of the polarizing film can be polymers capable of cross-linking by themselves, polymers capable of undergoing cross-linking reaction in the presence of a cross-linking agent, or combinations thereof. Examples of these binders-include methacrylate-series copolymer, styrene-series copolymers, polyolefins, polyvinyl alcohols (PVAs), modified PVAs, poly(N-methylolacrylamides), polyesters, polyimides, vinyl acetate copolymers, carboxymethyl celluloses, polycarbonates, and the like described in paragraph No. [0022] of JP-A-8-338913. A silane coupling agent can be used as a polymer.

Among these, water-soluble polymers (such as poly(N-methylolacrylamides)), carboxymethyl celluloses, gelatin, PVAs and modified PVAs are preferable; gelatin, PVAs and modified PVAs are more preferable; PVAs and modified PVAs are further preferable. It is particularly preferred to use two kinds of polyvinyl alcohols or modified polyvinyl alcohols having different polymerization degrees. PVAs usable in the present invention have a saponification degree in the range of, preferably 70 to 100%, more preferably 80 to 100%.

The suitable polymerization degree of the PVAs is from 100 to 5,000.

There are descriptions of the modified PVAs in JP-A-8-338913, JP-A-9-152509 and JP-A-9-316127. Two or more kinds of polyvinyl alcohols or modified polyvinyl alcohols may be used together.

The lower limit of the thickness of the binder is preferably 10 μm. The upper limit of the thickness is preferably as thin as possible from the viewpoint of light leakage from the liquid crystal display device. The thickness is preferably thinner than the thickness (about 30 μm) of polarizing plates commercially available at the present, more preferably 25 μm or less, and further preferably 20 μm or less.

The binder in the polarizing film may be crosslinked. A polymer or monomer having a crosslinkable functional group may be incorporated into the binder, or a crosslinkable functional group may be given to the binder polymer itself. The crosslinking may be attained by light, heat, or pH change, so as to make it possible to cause the binder to have a crosslinked structure. Crosslinking agents are described in U.S. Pat. Re-issue No. 23297. A boron compounds (such as boric acid or borax) also may be used as a crosslinking agent. The amount of the crosslinking agent added to the binder is preferably from 0.1 to 20 mass % of the binder. In this case, the orientation of the polarizer and the wet heat resistance of the polarizing film become good.

After the end of the crosslinking reaction, the amount of the crosslinking agent which has not reacted is preferably 1.0 mass % or less, more preferably 0.5 mass % or less. This way makes it possible to improve the weather resistance of the film.

(Drawing (Stretching) of the Polarizing Film)

It is preferable that the polarizing film is drawn (drawing process) or is rubbed (rubbing process), and subsequently the film is dyed with iodine or a dichroic dye.

In the case of the drawing process, the draw ratio of the film is preferably from 2.5 to 30.0 times, more preferably from 3.0 to 10.0 times. The drawing can be carried out by dry drawing in the air or wet drawing in the state that the film is immersed in water. The draw ratio in the dry drawing is preferably from 2.5 to 5.0 times, and the draw ratio in the wet drawing is preferably from 3.0 to 10.0 times. Herein, the drawing ratio is determined by the expression: (length of the polarizing film after the drawing)/(length of the polarizing film before the drawing). The drawing may be performed in parallel to the MD direction (parallel drawing), or obliquely (oblique drawing). This drawing may be attained by one drawing operation or plural drawing operations. The drawing based on the plural drawing operations makes it possible to draw the film homogeneously even when a high-ratio drawing is performed. More preferable is oblique drawing wherein the film is drawn at an angle of 10 to 80° oblique direction to the film.

(a) Parallel Drawing Process

Before the film is drawn, the PVA film may be swelled. The swelling degree thereof (the mass ratio of the film after the swelling to the film before the swelling) is preferably from 1.2 to 2.0. Thereafter, while the film may be continuously carried through guide rollers or the like, the film is drawn in an aqueous medium bath or a dyeing bath wherein a dichroic material is dissolved at a bath temperature of preferably from 15° C. to 50° C., more preferably from 17° C. to 40° C. The drawing can be attained by grasping the film by means of two pairs of nip rollers, the carrying rate of the backward nip rollers being made larger than that of the forward nip rollers. The draw ratio, which is the ratio of the length of the drawn film to that of the film at the initial stage (this being the same hereinafter), is preferably from 1.2 to 3.5 times, more preferably from 1.5 to 3.0 times, from the viewpoint of the above-mentioned effects and advantages. Thereafter, the film may be dried at a temperature of from 50 to 90° C., to yield a polarizing film.

(b) Oblique Drawing Process

As described in JP-A-2002-86554, the oblique drawing process can be carried out by drawing using a tenter projected in an oblique direction. Since this drawing is performed in the air, it is necessary to hydrate the film beforehand so as to make the film easy to draw. The water content in the film is preferably from 5 to 100%, more preferably from 10 to 100%.

The temperature when the film is drawn is preferably from 40° C. to 90° C., more preferably from 50° C. to 80° C. The humidity is preferably from 50 to 100% RH, more preferably from 70 to 100% RH, and further preferably from 80 to 100% RH. The advance speed in the longitudinal direction is preferably 1 m/minute or more, more preferably 3 m/minute or more.

After the end of the drawing, the film is dried at a temperature of preferably from 50° C. to 100° C., more preferably from 60° C. to 90° C., for preferably 0.5 to 10 minutes, more preferably 1 to 5 minutes.

The angle of the absorption axis of the thus-obtained polarizing film is preferably from 10° to 80°, more preferably from 30° to 60°, and further preferably substantially 45° (from 40° to 50°).

(Adhesion)

The saponified cellulose film and the polarizing film prepared by the drawing may be adhered to each other to prepare a polarizing plate. About the direction along which they are adhered to each other, the angle between the direction of the flow casting axis of the cellulose film and the draw axis of the polarizing plate is preferably set to 45°.

The adhesive agent for the adhesion is not particularly limited. Examples thereof include PVA-series resins (including modified PVAs modified with an acetoacetyl group, a sulfonic acid group, a carboxyl group, an oxyalkylene group or some other group); and an aqueous solution of a boron compound. Among these, the PVA-series resins are particularly preferable. The thickness of the adhesive agent layer is preferably from 0.01 to 10 μm, more preferably from 0.05 to 5 μm after the layer is dried.

It is more preferable that the light transmittance of the thus-obtained polarizing plate is higher and the polarization degree thereof is higher. The light transmittance of the polarizing plate at wavelength of 550 nm is preferably from 30 to 50%, more preferably from 35 to 50%, and most preferably from 40 to 50%. The polarization degree thereof at a wavelength of 550 nm is preferably from 90 to 100%, more preferably from 95 to 100%, and most preferably from 99 to 100%.

The thus-obtained polarizing plate may be laminated on a λ/4 plate, whereby a circular polarization plate can be produced. In this case, the laminating is preferably carried out to set the angle between the retardation axis of the λ/4 plate and the absorption axis of the polarizing plate to 45°. At this time, the λ/4 plate is not particularly limited, and is preferably a λ/4 plate having a wavelength dependency such that the retardation thereof is smaller at a lower wavelength. It is also preferable to use a polarizing film having an absorption axis inclined at an angle of from 20° to 70° to the longitudinal direction, and a λ/4 plate composed of an optically anisotropic layer made of a liquid crystal compound.

[Formation of Optical Compensation Layer (Production of Optical Compensation Sheet)]

The optical compensation layer is a layer for making compensation for a liquid crystal compound in a liquid crystal cell in a liquid crystal display device at the time of black display, and is prepared by forming an oriented film on the cellulose film and further forming an optically anisotropic layer thereon.

(Oriented Film)

An oriented film may be formed on the above-mentioned surface-treated cellulose film. This film has a function of deciding the orientation direction of liquid crystal molecules. However, if a liquid crystal compound is oriented and subsequently the orientation state is fixed, the oriented film is not necessarily essential as a constituent of the present invention since the oriented film has fulfilled the function thereof. In other words, only the optically anisotropic layer, which is in a fixed orientation state and is formed on the oriented film, may be transferred onto a polarizer, whereby the polarizing plate using the cellulose film of the present invention can be produced.

The orientation film can be provided by rubbing an organic compound (preferably a polymer), oblique evaporation of an inorganic compound, forming a layer having a micro group, or accumulation of an organic compound (for example, ω-tricosanoic acid, dioctadecylmethylammonium chloride or methyl stearate) by the Langmuir-Blodgett method (LB film). Furthermore, there have been known orientation films having an orienting function imparted thereto by applying an electrical field, applying a magnetic field or irradiating with light.

It is preferable to form the oriented film by subjecting a polymer to rubbing treatment. In principle, the polymer used in the oriented film has a molecular structure having a function of orienting liquid crystal molecules.

In the present invention, it is preferable to not only cause the polymer used in the oriented film to have the above-mentioned function of orienting liquid crystal molecules, but also introduce, into the main chain of the polymer, a side chain having a crosslinkable functional group (for example, a double bond), or introduce, into a side chain of the polymer, a crosslinkable functional group having a function of orienting liquid crystal molecules.

The polymers used in the oriented film may be polymers capable of cross-linking by themselves, polymers capable of undergoing cross-linking reaction in the presence of a cross-linking agent, or combinations thereof. Examples of the polymers include styrene-series copolymers, polyolefins, polyvinyl alcohols (PVAs), modified PVAS, poly(N-methylolacrylamides), polyesters, polyimides, vinyl acetate copolymers, carboxymethyl celluloses, polycarbonates, methacrylate-series copolymers described in paragraph No. [0022] of JP-A-8-338913, compounds such as a silane coupling agent, and the like. Of these polymers, water-soluble polymers (such as poly(N-methylolacrylamides)), carboxymethyl celluloses, gelatin, PVAs and modified PVAs are preferred. Further, gelatin, PVAs and modified PVAs are more preferable, PVAs and modified PVAs are most preferable. It is particularly preferable to use two kinds of polyvinyl alcohols or modified polyvinyl alcohols having different polymerization degrees. The PVAs have a saponification degree in the range of, preferably 70 to 100%, more preferably 80 to 100%. The suitable polymerization degree of the PVAs is from 100 to 5,000.

The side chain having a function of orienting liquid crystal molecules, in general, has a hydrophobic group as a functional group. The specific kind of the functional group is decided dependently on the kind of the liquid crystal molecules and a required orientation state.

Modifying groups of the modified polyvinyl alcohol can be introduced by copolymerization, chain transfer or block polymerization. Examples of the modifying group include a hydrophilic group (e.g., a carboxylic group, a sulfonic group, a phosphonic group, an amino group, an ammonium group, an amido group, and a thiol group), a hydrocarbon group having 10 to 100 carbon atoms, a fluorine-substituted hydrocarbon group, a thioether group, a polymerizable group (e.g., an unsaturated polymerizable group, an epoxy group, an aziridinyl group), and an alkoxysilyl group (e.g., a trialkoxysilyl group, a dialkoxysilyl group, and a monoalkoxysilyl group). Specific examples of the modified polyvinyl alcohols include ones described in JP-A-2000-155216, paragraph Nos. [0022] to [0145], and JP-A-2002-62426, paragraph Nos. [0018] to [0022].

When a side chain having a crosslinkable functional group is bonded to the main chain of the oriented film polymer or a crosslinkable functional group is introduced into the side chain having a function of orienting liquid crystal molecules, the oriented film polymer can be copolymerized with a polyfunctional monomer contained in the optically anisotropic layer. As a result, strong bonding based on covalent bonds is attained between the polyfunctional monomer molecules, between the oriented film polymer molecules, and between the polyfunctional monomer molecule and the oriented film polymer molecule. Consequently, the introduction of the crosslinkable functional group into the oriented film polymer makes it possible to improve the strength of the optical compensation sheet remarkably.

The crosslinkable functional group of the oriented film polymer preferably contains a polymerizable group in the same manner as the polyfunctional monomer. Specific examples thereof include ones described in JP-A-2000-155216, paragraph Nos. [0080] to [0100]. The oriented film polymer can be crosslinked with a crosslinking agent, separately from the above-mentioned crosslinkable functional group.

Examples of the crosslinking agent include aldehydes, N-methylol compounds, dioxane derivatives, compounds that works when a carboxylic group is activated, active vinyl compounds, active halogen compounds, isooxazoles and dialdehyde starch. Two or more crosslinking agents may be used in combination. Compounds described in, e.g., JP-A-2002-62426, paragraph Nos. [0023] to [0024] can be used. Among these, aldehydes having high activity are preferred, and glutaraldehyde is particularly preferred.

The amount of the crosslinking agent to be added is in the range of preferably 0.1 to 20 mass %, more preferably 0.5 to 15 mass % based on the amount of the polymer. The amount of non-reacted crosslinking agent remaining in the orientation film is preferably 1.0 mass % or less, more preferably 0.5 mass % or less based on the amount of the orientation film. The adjustment as described above makes it possible to give a sufficient endurance to the oriented film without generating any reticulation even if the oriented film is used in a liquid crystal display device for a long time or is allowed to stand still in high-temperature and high-humidity atmosphere for a long time.

The oriented film can be basically formed by coating a solution containing the polymer (the oriented film-forming material) and the cross-linking agent as recited above on a transparent substrate, drying by heating (to cause cross-linking reaction) and rubbing the coating surface. The cross-linking reaction, as mentioned above, may be carried out in an arbitrary stage after coating the solution on the transparent substrate. In the case of using a water-soluble polymer, such as PVA, as the oriented film-forming material, a mixture of water with an organic solvent having a defoaming action, such as methanol, is preferably employed as the solvent of the coating solution. The suitable ratio of water to methanol is preferably from 0:100 to 99:1, more preferably from 0:100 to 91:9, by mass. By the use of such a mixed solvent, the generation of foams can be prevented to ensure markedly decreased defects in the oriented film, especially the surface of the optically anisotropic layer.

Examples of a coating method for the oriented film include a spin coating method, a dip coating method, a curtain coating method, an extrusion coating method, a rod coating method and a roll coating method. Of these methods, the rod coating method is preferred over the others. The thickness of the film after drying is preferably from 0.1 to 10 μm. The drying by heating can be generally performed at a temperature of 20° C. to 110° C. In order to form cross-links to a satisfactory extent, the drying temperature is preferably from 60° C. to 100° C., particularly preferably from 80° C. to 100° C. The drying time is generally from 1 minute to 36 hours, preferably from 1 to 30 minutes. Further, it is preferable to adjust the pH to an optimum value for the cross-linking agent used. In the case of using glutaraldehyde as a cross-linking agent, the pH is preferably from 4.5 to 5.5, more preferably 5.

The orientation layer may be provided on the transparent support or an undercoating layer. After the above-described polymer layer is crosslinked, the surface of the layer may be subjected to rubbing treatment to form the orientation layer.

For the rubbing treatment, can be adopted the treatment methods widely used for orientating liquid crystals at the time of producing the liquid crystal display. More specifically, the method of rubbing the surface of an orientation film in a fixed direction by means of paper, gauze, felt, rubber, or nylon or polyester fiber can be employed for orientation. In general, the rubbing treatment can be carried out by rubbing several times the polymer surface with cloth into which fibers having the same length and the same diameter are transplanted evenly.

When the rubbing treatment method is carried out industrially, it can be achieved by contacting a rotating rubbing roll with a transported film having a polarizing film. The circularity, cylindricality and deflection of the roll itself are preferably all 30 μm or below. The wrap angle of a film with a rubbing roll is preferably from 0.10 to 90°. However, as described in JP-A-8-160430, there is a case that the steady rubbing treatment is effected by winding a film around the roll at an angle of 360° or more. It is preferable that the film is conveyed at a speed of 1 to 100 meters per minute. Further, it is appropriate to choose the rubbing angle from the range of 0° to 60°. In the case of using the rubbed film for liquid crystal displays, it is preferable to set the rubbing angle from 40° to 50°. In particular, it is advantageous to adjust the rubbing angle to 45°.

The film thickness of the thus-obtained oriented film is preferably from 0.1 to 10 μm.

(Optically Anisotropic Layer)

Next, liquid crystal molecules of an optically anisotropic layer may be oriented onto the oriented film. Thereafter, the oriented film polymer may be caused to react with the polyfunctional monomer contained in the optically anisotropic layer, or a crosslinking agent may be used to crosslink the oriented film polymer, if necessary.

The liquid crystal molecules used in the optically anisotropic layer may be rod-like liquid crystal molecules or disk-like liquid crystal molecules. The rod-like liquid crystal molecule and the disk-like liquid crystal molecule may each be a high molecular weight liquid crystal or a low molecular weight liquid crystal. Furthermore, a compound about which a low molecular weight liquid crystal is crosslinked to exhibit no liquid crystallinity may be used.

1) Rod-Like Liquid Crystal Molecule

Specific examples of the rod-like liquid crystal compounds that can be preferably used include azomethines, azoxy compounds, cyanobiphenyls, cyanophenylesters, benzoic esters, cyclohexane carboxylic acid phenylesters, cyanophenylcyclohexane compounds, cyano-substituted phenylpyrimidines, alkoxy-substituted phenylpyrimidines, phenyldioxanes, tolan compounds, alkenylcyclohexylbenzonitrils, and the like.

The rod-like liquid crystal molecule may include a metal complex. A liquid crystal polymer containing, as recurring units thereof, rod-like liquid crystal molecules can also be used as the rod-like liquid crystal molecule. In other words, the rod-like liquid crystal molecule may be bonded to a (liquid crystal) polymer.

Rod-like liquid crystal molecules are described in Quarterly Chemical Review, Vol. 22, “Chemistry of Liquid Crystal” edited by the Chemical Society of Japan (1994), Chapters 4, 7, and 11, and “Liquid Crystal Device Handbook” edited by Japan Society for the Promotion of Science, 142nd Committee, chapter 3.

The birefringence of the rod-like liquid crystal molecules is preferably from 0.001 to 0.7.

The rod-like liquid crystal molecule preferably has a polymerizable group in order to fix the orientation state thereof. The polymerizable group is preferably a radical polymerizable unsaturated group or a cation polymerizable group. Specific examples thereof include polymerizable groups and polymerizable liquid crystal compounds described in JP-A-2002-62427, paragraph Nos. [0064] to [0086].

2) Disk-Like Liquid Crystal Molecule

Illustrative of the disk-like (discotic) liquid crystal molecule can include benzene derivatives disclosed in a study report of C. Destrade et al., Mol. Cryst., vol. 71, page 111 (1981); truxene derivatives disclosed in a study report of C. Destrade et al., Mol. Cryst., vol. 122, page 141 (1985), and Phyics. Lett., A, vol. 78, page 82 (1990); cyclohexane derivatives disclosed in a study report of B. Kohne et al., Angew. Chem. Soc., vol. 96, page 70 (1984); and macrocycles of azacrown series and phenylacetylene series disclosed in a study report of J. M. Lehn et al., J. Chem. Commun. page 1794 (1985), and a study report of and J. Zhang et al., J. Am. Chem. Soc. vol. 116, page 2655 (1994).

The above disk-like liquid crystal molecule may include compounds which show mesomorphism (liquid crystallinity) and have a structure in which straight chain groups such as a alkyl group and an alkoxy group, and/or substituted benzoyloxy groups are radially substituted as side chains of a parent core locating at the center of the molecule. The molecule or a cluster of the molecules is preferably the compound which has rotational symmetry and can give a given orientation. About the optically anisotropic layer made from the disk-like liquid crystal molecules, it is unnecessary that the compound which is finally contained in the optically anisotropic layer is made of a disk-like liquid crystal molecule. For example, the optically anisotropic layer may be made of a low molecular weight disk-like liquid crystal molecule having a thermo- or photo-reactive group which is resultantly polymerized or crosslinked by heat or light to form a polymer that does not behave as liquid crystal. Preferred examples of the disk-like liquid crystal molecule are described in JP-A-8-50206. JP-A-8-27284 discloses polymerization of the disk-like liquid crystal molecule.

In order to fix the disk-like liquid crystal molecule by polymerization, it is necessary to bond a polymerizable group as a substituent to the disk-like core of the disk-like liquid crystal molecule. A compound wherein the disk-like core and the polymerizable group are bonded through a linking group is preferred. By this structure, the orientation state of the compound can be kept in the polymerization reaction. Examples of the compound include compounds described in JP-A-2000-155216, paragraph Nos. [0151] to [0168].

In hybrid orientation, an angle between major axis (disc plane) of disk-like liquid crystal molecule and plane of polarizing film increases or decreases with increase of distance from plane of polarizing film and in the direction of depth from the bottom of the optically anisotropic layer. The angle preferably decreases with increase of the distance. Further, examples of variation of the angle include continuous increase, continuous decrease, intermittent increase, intermittent decrease, variation containing continuous increase and decrease, and intermittent variation containing increase or decrease. The intermittent variation contains an area where the inclined angle does not vary in the course of the thickness direction of the layer. It is sufficient if the angle totally increases or decreases in the layer, even though there is an area where the inclined angle does not vary in the course. Further, it is preferred that the angle vary continuously.

Average direction of major axis of disk-like liquid crystal molecule on the polarizing film side can be generally controlled by selecting the disk-like liquid crystal molecule or materials of the orientation film, or by selecting methods for the rubbing treatment. The direction of major axis (disc plane) of disk-like liquid crystal molecule on the surface side (air side) can be generally controlled by selecting the disk-like liquid crystal molecule or additives used together with the disk-like liquid crystal molecule. Examples of the additives used together with the disk-like liquid crystal molecule include plasticizer, surface active agent, polymerizable monomer and polymer. Further, the extent of variation of the orientation direction of the major axis can be also controlled by the above selection.

(Other Components of the Optically Anisotropic Layer)

The use of a plasticizer, a surfactant, a polymerizable monomer and others together with the liquid crystal molecules makes it possible to improve the uniformity of the coating film to be obtained, the strength of the film, the orientation of the liquid crystal molecules, and others. It is preferable that these components are compatible with the liquid crystal molecules and can change the tilt angle of the liquid crystal molecules or do not hinder the orientation.

The polymerizable monomer may be a radical polymerizable compound or a cation polymerizable compound, and is preferably a polyfunctional radical polymerizable monomer. Preferably, the polymerizable monomer is a monomer copolymerizable with the above-mentioned liquid crystal compound having the polymerizable group. Examples thereof include monomers described in JP-A-2002-296423, paragraph Nos. [0018] to [0020]. The added amount of the compound is preferably from 1 to 50 mass %, more preferably from 5 to 30 mass % of the disk-like liquid crystal molecules.

The surfactant may be a conventional compound. A fluorine-containing compound is particularly preferable. Specific examples thereof include compounds described in JP-A-2001-330725, paragraph Nos. [0028] to [0056].

It is preferable that the polymer used together with the disk-like liquid crystal molecules can change the tilt angle of the disk-like liquid crystal molecules.

Examples of the polymer include a cellulose acylate. Preferable examples of the cellulose acylate are described in JP-A-2000-155216, paragraph No. [0178]. In order not to hinder the orientation of the liquid crystal molecules, the added amount of the polymer is preferably from 0.1 to 10 mass %, more preferably from 0.1 to 8 mass % of the liquid crystal molecules.

The transition temperature from discotic-nematic liquid-crystal phase to solid phase is preferably in the range of 70 to 300° C., especially 70 to 170° C.

(Formation of Optically Anisotropic Layer)

The optically anisotropic layer can be formed by applying a coating solution, which contains the liquid crystal molecule together with the following polymerization initiator and other additives, onto the orientation film.

As the solvent to be used in preparing the coating solution, it is preferable to use an organic solvent. Examples of the organic solvent include amides (for example, N,N-dimethylformamide), sulfoxides (for example, dimethyl sulfoxide), heterocyclic compounds (for example, pyridine), hydrocarbons (for example, benzene and hexane), alkyl halides (for example, chloroform, dichloromethane and tetrachloroethane), esters (for example, methyl acetate and butyl acetate), ketones (for example, acetone and methyl ethyl ketone) and ethers (for example, tetrahydrofuran and 1,2-dimethoxyethane). Alkyl halides and ketones are preferred. It is also possible to use two or more organic solvents together.

The coating solution can be applied by a publicly known method (for example, the wire bar coating method, the extrusion coating method, the direct gravure coating method, the reverse gravure coating method or the die coating method).

The film thickness of the optically anisotropic layer is preferably from 0.1 to 20 μm, more preferably from 0.5 to 15 μm, and most preferably from 1 to 10 μm.

(Fixation of the Oriented State of a Liquid Crystal Molecule)

The liquid crystal molecule thus oriented can be fixed while holding the oriented state. The fixation is preferably carried out by the polymerization reaction. The polymerization reaction includes a heat polymerization reaction with the use of a heat polymerization initiator and a photopolymerization reaction with the use of a photopolymerization initiator. The photopolymerization reaction is preferred.

Examples of the photopolymerization initiator include α-carbonyl compounds (described in U.S. Pat. Nos. 2,367,661 and 2,367,670), acyloin ether (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of a triarylimidazole dimer with p-aminophenyl ketone (described in U.S. Pat. No. 3,549,367), acridine and phenazine compounds (described in JP-A-60-105667 and U.S. Pat. No. 4,239,850) and oxadiazol compounds (described in U.S. Pat. No. 4,212,970).

It is preferable to use the photopolymerization initiator in an amount of from 0.01 to 20 mass %, more preferably from 0.5 to 5 mass %, based on the solid matters in the coating solution.

In the photoirradiation for polymerizing the liquid crystal molecule, it is preferable to use UV light.

The irradiation energy preferably ranges from 20 mJ/cm² to 50 J/cm², more preferably from 20 to 5,000 mJ/cm², and further preferably from 100 to 800 mJ/cm². To accelerate the photopolymerization reaction, the photoirradiation may be carried out under heating.

A protective layer may be formed on the optically anisotropic layer.

(Combination of Optical Compensation Film with Polarizing Film)

It is also preferable to combine this optical compensation film with the polarizing film. Specifically, a coating solution for forming optically anisotropic layers, as described above, is applied onto the surface of a polarizing film, thereby forming an optically anisotropic layer. As a result, produced is a thin polarizing plate giving only a small stress (strain×sectional area×elastic modulus) with a change in the size of the polarizing film without using any polymer film between the polarizing film and the optically anisotropic layer. By fitting a polarizing plate comprising the cellulose film according to the present invention into a large-sized liquid crystal display device, images having a high display quality can be displayed without causing problems, such as light leakage.

The tilt angle between the polarizing film and the optically compensating layer is preferably adjusted by drawing them in such a manner that the angle is matched with the angle between the transmission axis of two polarizing plates adhered onto both surfaces of a liquid crystal cell which constitutes a LCD and the lengthwise or lateral direction of the liquid crystal cell. Such an angle is generally 45°, but it is not always 45° in some of the latest transmission, reflection or semi-transmission type LCD modes. Therefore, it is preferable that the drawing direction be adjustable in order to conform to the design of LCD.

[Formation of Antireflection Layer (Formation of Antireflection Film)]

An antireflection film is generally formed by laying a low refractive index layer, which functions as an antifouling property layer also, and at least one layer having a higher refractive index than that of the low refractive index layer, i.e., a high refractive index layer and/or a middle refractive index layer, on a transparent substrate.

Examples of the method for forming a multilayered film wherein transparent thin films made of inorganic compounds (such as metal oxides) having different refractive indexes are laminated include a chemical vapor deposition (CVD) method; a physical vapor deposition (PVD) method; and a method of forming a metal compound such as metal alkoxide into a film made of colloidal metal oxide particles by a sol-gel method, and subjecting the film to post-treatment (such as ultraviolet radiation described in JP-A-9-157855, or plasma treatment described in JP-A-2002-327310).

As antireflection films having a high productivity, suggested are various antireflection films obtained by laminating thin films, each of which is made of inorganic particles dispersed in a matrix, by coating. The antireflection film may be an antireflection film produced by making fine irregularities in the outermost surface of the antireflection film formed by coating to give anti-glare property to the surface.

Any one of the above-mentioned manners can be applied to the cellulose film of the present invention. The coating manner (coating type) is preferable.

(Layer Structure of the Coating Type Antireflection Film)

An antireflection film at least having a layer structure obtained by forming, on a transparent support, a middle refractive index layer, a high refractive index layer, and a low refractive index layer (the outermost layer) in this order, is preferably designed to have refractive indexes satisfying the following relationship.
(The refractive index of the high refractive index layer)>(the refractive index of the middle refractive index layer)>(the refractive index of the transparent substrate)>(the refractive index of the low refractive index layer)

A hard coat layer may be formed between the transparent support and the middle refractive index layer. The antireflection film may be composed of a middle refractive index hard coat layer, a high refractive index layer, and a low refractive index layer. Examples thereof are described in JP-A-8-122504, JP-A-8-110401, JP-A-10-300902, JP-A-2002-243906, and JP-A-2000-111706:

A different function may be given to each of the layers. Examples thereof include a low refractive index layer having antifouling property, and a high refractive index layer having antistatic property (for example, described in JP-A-10-206603, JP-A-2002-243906, and the like).

The haze of the antireflection film is preferably 5% or less, more preferably 3% or less. The mechanical strength of the film is preferably H or harder, further preferably 2H or harder, and most preferably 3H or harder, in terms of the pensile hardness test, according to JIS K5400.

(High-Refractive-Index Layer and Middle-Refractive-Index Layer)

The layer having a higher refractive index of the antireflection film is generally made of a curable film containing at least inorganic compound superfine particles having a high refractive index and an average particle size of 100 nm or less, and matrix binder.

The high refractive index, inorganic compound superfine particles may be made of an inorganic compound having a refractive index of 1.65 or more, preferably are a refractive index of 1.9 or more. Examples of the inorganic compound to be preferably used, include oxides of Ti, Zn, Sb, Sn, Zr, Ce, Ta, La, In, and the like; and composite oxides containing two or more out of these metal atoms.

Examples of the embodiment of such superfine particles to be used, include the particles whose surface is treated with a surface-treating agent (such as a silane coupling agent, as described in JP-A-11-295503, JP-A-11-153703, and JP-A-2000-9908, or an anionic compound or an organometallic coupling agent, as described in JP-A-2001-310432, and the like), the particles in which a core-shell structure is formed to have high refractive index particles be a core (as described in JP-A-2001-166104 and the like), and the particles to be used in combination with a specific dispersing agent (as described in JP-A-11-153703, U.S. Pat. No. 6,210,858 B1, JP-A-2002-2776069, and the like). The material which forms the matrix may be any of known thermoplastic resins and thermosetting resin coatings.

The material is preferably at least one composition selected from a composition comprising a polyfunctional compound containing at least two radical polymerizable groups and/or cation polymerizable groups, a composition comprising an organometallic compound containing a hydrolyzable group, and a composition comprising a partial condensate thereof. Examples of the compounds to be used in the composition include compounds described in JP-A-2000-47004, JP-A-2001-315242, JP-A-2001-31871, and JP-A-2001-296401.

Alternately, a curable film obtained from a metal alkoxide composition and a colloidal metal oxide formed from a hydrolysis condensate of a metal alkoxide is preferably used. Examples thereof include a curable film described in JP-A-2001-293818 and the like.

The refractive index of the high-refractive-index layer is preferably in the range of 1.70 to 2.20. The thickness of the high-refractive-index layer is preferably from 5 nm to 10 μm, more preferably from 10 nm to 1 μm.

The refractive index of the middle-refractive-index layer is adjusted so as to become a value (magnitude) between the refractive index of the low-refractive-index layer and the refractive index of the high-refractive-index layer. The refractive index of the middle-refractive-index layer is preferably in the range of more than 1.50 and less than 1.70.

(Low-Refractive-Index Layer)

The low-refractive-index layer is generally laminated on the high refractive index layer. The low-refractive-index layer has a refractive index preferably in the range of 1.20 to 1.55, more preferably in the range of 1.30 to 1.50.

The low-refractive-index layer is preferably formed as an outermost layer having scratch resistance and antifouling property. In order to improve the scratch resistance largely, it is effective to give lubricity to the surface. For this, it is possible to use the method of forming a thin film layer by the introduction of a conventionally-known silicone compound or a fluorine-containing compound.

The refractive index of the fluorine-containing compound is preferably 1.35 to 1.50, more preferably 1.36 to 1.47. The fluorine-containing compound is preferably a compound containing 35 to 80 mass % of fluorine atoms and a crosslinkable or polymerizable functional group.

As the fluorine-containing compound, for example, the following compounds can be preferably used: compounds described in JP-A-9-222503, paragraph Nos. [0018] to [0026]; JP-A-11-38202, paragraph Nos. [0019] to [0030]; JP-A-2001-40284, paragraph Nos. [0027] to [0028]; JP-A-2000-284102, and the like.

The silicone-containing compound is preferably a compound which has a polysiloxane structure; and more preferably a compound which contains, in the polymer chain thereof, a curable functional group or polymerizable functional group so as to have a crosslinked structure in the film to be formed. Examples thereof include reactive silicones (such as “Silaplane” (trade name), manufactured by Chisso Corporation), and polysiloxane containing, at both ends thereof, silanol groups (described in JP-A-11-258403), and the like.

It is preferable to conduct the crosslinking or polymerizing reaction of the fluorine-containing polymer and/or siloxane polymer having a crosslinkable or polymerizable group, by radiation of light or heating, at the same time of or after applying a coating composition for forming an outermost layer containing a polymerization initiator, a sensitizer, and others.

Preferable is also a sol-gel cured film obtained by curing an organometallic compound, such as a silane coupling agent, and a silane coupling agent which contains a specific fluorine-containing hydrocarbon group, in the presence of a catalyst, by condensation reaction.

Examples thereof include silane compounds which contain a polyfluoroalkyl group, or partially-hydrolyzed condensates thereof (such as those described in JP-A-58-142958, JP-A-58-147483, JP-A-58-147484; JP-A-9-157582 and JP-A-11-106704), and silyl compounds which contains a poly(perfluoroalkyl ether) group, which is a long chain group containing fluorine (such as compounds described in JP-A-2000-117902, JP-A-2001-48590, and JP-A-2002-53804).

It is also preferable that the low refractive index layer is made to contain, as an additive other than the above, a filler {such as silicon dioxide (silica); low refractive index inorganic compound particles having a primary average particle diameter of 1 to 150 nm made, for example, of fluorine-containing particles (e.g. magnesium fluoride, calcium fluoride, barium fluoride); organic fine particles, as described in JP-A-11-3820, paragraph Nos. [0020] to [0038]}, a silane coupling agent, a lubricant, a surfactant; and the like.

In the case that the low refractive index layer is positioned beneath the outermost layer, the low refractive index layer may be formed by a gas phase method (such as a vacuum vapor deposition method, a sputtering method, an ion plating method, or a plasma CVD method). The low refractive index layer is preferably formed by a coating method, since the layer can be formed at low costs.

The thickness of the low-refractive-index layer is preferably from 30 to 200 nm, more preferably from 50 to 150 nm, and most preferably from 60 to 120 nm.

(Hardcoat Layer)

A hardcoat layer can be formed on the surface of a transparent support, to provide a physical strength with the antireflection film. In particular, the hardcoat layer is preferably disposed between the transparent support and the high-refractive index layer.

The hard coat layer is preferably formed by crosslinking reaction or polymerizing reaction of a curable compound through light and/or heat. The curable functional group thereof is preferably a photopolymerizable functional group. An organometallic compound which contains a hydrolyzable functional group is preferably an organic alkoxysilyl compound.

Specific examples of these compounds are the same as those exemplified as the high refractive index layer.

Specific examples of the composition which constitutes the hard coat layer to be preferably used, include compositions described in JP-A-2002-144913, JP-A-2000-9908, and WO 00/46617.

The high refractive index layer can function as a hard coat layer also. In this case, it is preferable to form a hard coat layer by incorporating fine particles finely dispersed according to the manner described above on the high refractive index layer.

The hard coat layer may contain particles having an average particle size of 0.2 to 10 μm, so as to be caused to function as an anti-glare layer also. The anti-glare layer has an anti-glare function (which will be detailed in the below).

The film thickness of the hard coat layer, which may be appropriately set according to the application thereof, is preferably from 0.2 to 10 μm, more preferably from 0.5 to 7 μm.

The mechanical strength of the hard coat layer is preferably H or harder, further preferably 2H or harder, and most preferably 3H or harder, in terms of the pensile hardness, according to JIS K5400 test. Further, it is preferable that the hard coat layer is less in an abraded amount in a taber test according to JIS K5400, which means a test piece made of said hardcoat layer is less in the abraded amount after the test.

(Forward Scattering Layer)

A forward scattering layer may be fitted to a liquid crystal display device in order to improve the viewing angle of the display device when the visual angle is inclined up and down or right and left. The hard coat layer can have both of a hard coat function and a forward scattering function by dispersing fine particles having different refractive indexes in the hard coat layer.

For example, any of the following techniques may be used, which are described in JP-A-11-38208 in which the forward scattering coefficient is specified, in JP-A-2000-199809 in which the relative refractive indexes of a transparent resin and fine-particles are made to fall in the specific ranges, respectively, and in JP-A-2002-107512 in which the haze value is made to be 40% or more.

(Other Layers)

In addition to the above layers, a primer layer, an anti-static layer, an undercoating layer, a protective layer and the like may be provided.

(Coating Methods)

The respective layers of the antireflection film can be formed by application, according to any one of dip coat, air knife coat, curtain coat, roller coat, wire bar coat, gravure coat, micro gravure coat, and extrusion coat (described in U.S. Pat. No. 2,681,294) methods.

(Antiglare Function)

The anti-reflection film may have an antiglare function for scattering light from the outside. The antiglare function can be obtained by making unevenness in a surface of the anti-reflection film. In the case that the anti-reflection film has the antiglare function, the haze of the anti-reflection film is preferably 3 to 30%, more preferably 5 to 20%, and most preferably 7 to 20%.

In order to form irregularities in the surface of the antireflection film, any method capable of forming the irregularities and keeping the resultant surface form sufficiently can be used. Examples of the method include a method of using fine particles in the low refractive index layer to form irregularities in the surface of the film (see, for example, JP-A-2000-271878); a method of adding a small amount (0.1 to 50 mass %) of relatively large particles (particle size: 0.05 to 2 μm) to the layer (high refractive index layer, middle refractive index layer or hard coat layer) to be formed beneath the low refractive index layer so as to form a surface uneven film, and then forming the low refractive index layer thereon while keeping this surface uneven form (see, for example, JP-A-2000-281410, JP-A-2000-95893, JP-A-2001-100004, and JP-A-2001-281407); and methods of transferring uneven forms physically onto the surface of an outermost layer (antifouling layer) formed by coating (see, for example, JP-A-63-278839, JP-A-11-183710 and JP-A-2000-275401 as embossing methods).

<Liquid Crystal Display Devices>

The cellulose film of the present invention, and polarizing plate, retardation film and optical film, each containing the cellulose film, can be preferably applied to liquid crystal display devices of various display modes. As the display devices, proposed are those having various modes, for example, TN type, IPS type, FLC type, AFLC type, OCB type, STN type, ECB type, VA type, and HAN type. Further, the cellulose film of the present invention is also preferably used in any of transparent-type, reflection-type, and semitransparent-type liquid crystal display devices. Each of liquid crystal modes is described hereinafter.

(TN-Type Liquid Crystal Display Device)

The cellulose film of the present invention can be used as a support for an optical compensation sheet that is used in TN type liquid crystal display devices having the liquid crystal cell of TN mode. The TN mode liquid crystal cell and the TN-type liquid crystal display device per se are well known for a long time. The optical compensation sheet that is used in TN-type liquid crystal display devices can be prepared in accordance with the method described in, for example, JP-A-3-9325, JP-A-6-148429, JP-A-8-50206, and JP-A-9-26572, and also described in, for example, papers authored by Mori, et al. (Jpn. J. Appl. Phys., Vol. 36 (1997), p. 143, and Jpn. J. Appl. Phys., Vol. 36 (1997), p. 1068).

(STN-Type Liquid Crystal Display Device)

The cellulose film of the present invention may be used as a support for an optical compensation sheet that is employed in STN-type liquid crystal display devices installing a STN mode liquid crystal cell. In STN-type liquid crystal display devices, generally, rod-like mesomorphism molecules in the liquid crystal cell is twisted in the range of 90 to 360 degrees, and the product (Δnd) of the cell gap (d) and refractive index anisotropy (Δn) of the rod-like mesomorphism molecular is in the range of 300 to 1,500 nm. Regarding optical compensation sheets used for the STN type liquid crystal display devices, it can be prepared in a accordance with the method described in JP-A-2000-105316.

(VA-Type Liquid Crystal Display Device)

The cellulose film of the present invention can be particularly advantageously used as a support for an optical compensation sheet that is used in the VA-type liquid crystal display devices installing a VA mode liquid crystal cell. It is preferred that the Re retardation value is controlled to the range of from 0 to 150 nm and the Rth retardation value is controlled to the range of from 70 to 400 nm, respectively, for the optical compensation sheet that is used in the VA-type liquid crystal display device. In an embodiment where two sheets of optically anisotropic polymer films are used in a VA-type liquid crystal display device, it is preferred that the Rth retardation value of the film is in the range of from 70 to 250 nm. In an embodiment where one sheet of an optically anisotropic polymer film is used in a VA-type liquid crystal display device, it is preferred that the Rth retardation value of the film is in the range of from 150 to 400 nm. The VA-type liquid crystal display device may have an orientation dividing system, as described in, for example, JP-A-10-123576.

(IPS-Type Liquid Crystal Display Device and ECB-Type Liquid Crystal Display Device)

The cellulose film of the present invention may also be advantageously used for the optical compensation sheet or as the protective film of the polarizing plate, in an IPS-type liquid crystal display device or ECB-type liquid crystal display device in which an IPS-mode or ECB-mode liquid crystal cell is assembled. In these modes, a mesomorphism (liquid crystal) material is oriented almost in parallel when a black color is displayed, and a mesomorphism molecule is oriented in parallel to the surface of the substrate in the condition that no voltage is applied, to display a black color. In these modes, the polarizing plate using the cellulose film of the present invention contributes to improvement in color hue, expansion of the viewing angle, and improvement in contrast. In these modes, it is preferable that use is made of, for at least one side of the two polarizing plates, a polarizing plate in which the cellulose film of the present invention is used for the protective film (a cell-side protective film) disposed between the liquid crystal cell and the polarizing plate, of the protective films of the above polarizing plates on the upper and lower sides of the liquid crystal cell. It is more preferable that an optical anisotropic layer be disposed between the protective film of the polarizing plate and the liquid crystal cell, and that the retardation value of the disposed optical anisotropic layer be set to a value not more than twice the value of Δn-d of the liquid crystal layer.

(OCB-Type Liquid Crystal Display Device and HAN-Type Liquid Crystal Display Device)

The cellulose film of the present invention can also be advantageously used as a support for an optical compensation sheet that is used in an OCB-type liquid crystal display device having a liquid crystal cell of OCB mode, or used in a HAN-type liquid crystal display device having a liquid crystal cell of HAN mode. It is preferable that, in the optical compensation sheet used for an OCB-type liquid crystal display device or a HAN-type liquid crystal display device, the direction where the magnitude or absolute value of retardation becomes the minimum value exists neither in the optical compensation sheet plane nor in its normal direction. Optical properties of the optical compensation sheet for use in the OCB type liquid crystal display device or the HAN type liquid crystal display device are also determined by the optical properties of the optical anisotropy layer, by the optical properties of the support, and by the arrangement of the optical anisotropy layer and the support. JP-A-9-197397 describes, regarding the optical compensation sheet for use in the OCB type liquid crystal display device or HAN type liquid crystal display device. In addition, a paper by Mori et al. (Jpn. J. Appl. Phys., Vol. 38 (1999), p. 2837) describes about it.

(Reflection-Type Liquid Crystal Display Device)

The cellulose film of the present invention can also be advantageously used as an optical compensation sheet for the reflection-type liquid crystal display devices of TN-type, STN-type, HAN-type, or GH (Guest-host)-type. These display modes are well known for a long time. The TN-type reflection-type liquid crystal display devices are described in, for example, JP-A-10-123478, WO 98/48320, and Japanese Patent No. 3022477. The optical compensation sheet for use in a reflection type liquid crystal display device is described in, for example, WO 00/65384.

(Other Liquid Crystal Display Devices)

The cellulose film of the present invention can also be advantageously used as a support for an optical compensation sheet for use in ASM (Axially Symmetric Aligned Microcell) type liquid crystal display devices having a liquid crystal cell of ASM mode. The liquid crystal cell of ASM mode is characterized in that a resin spacer adjustable with its position maintains the thickness of the cell. Other properties of the liquid crystal cell of ASM mode are similar to the properties of the liquid crystal cell of TN mode. Regarding liquid crystal cells of ASM mode and ASM type liquid crystal display devices, descriptions can be found in a paper of Kume et al. (Kume et al., SID 98 Digest 1089 (1998)).

(TN Mode Liquid Crystal Display Device)

The liquid crystal cell of TN mode is widely used in color TFT liquid crystal displays, and hence is described in many publications. In a liquid crystal cell in the TN mode, the orientation state of the liquid crystal therein at the time of black display is the state that rod-like liquid crystal molecules in the central portion of the cell stand up and the molecules lie down in portions near substrates of the cells.

(OCB Mode Liquid Crystal Display Device)

The liquid crystal cell of OCB mode is a liquid crystal cell of bend orientation mode in which rod-like liquid crystal molecules in upper part and ones in lower part are essentially reversely (symmetrically) oriented. A liquid crystal display device having the liquid crystal cell of bend orientation mode is disclosed in U.S. Pat. Nos. 4,583,825 and 5,410,422. Since rod-like liquid crystal molecules in upper part and ones in lower part are symmetrically oriented, the liquid crystal cell of bend orientation mode has self-optical compensatory function. Therefore, this mode is referred to as OCB (optically compensatory bend) mode.

In the same manner as in the TN mode, in a liquid crystal cell in the OCB mode, the orientation state of the liquid crystal in the cell at the time of black display is the state that rod-like liquid crystal molecules in the central portion of the cell stand up and the molecules lie down in portions near substrates of the cells.

According to the present invention, it is possible to provide a cellulose film having reverse dispersion of wavelength dispersion of in-plane retardation (Re), and allowing free control of the Re value and the wavelength dispersion of retardation (Rth) in the thickness direction in wide ranges; a cellulose compound for used in the cellulose film; and an optical compensation sheet, a polarizing plate and a liquid crystal display device, prepared by using the same.

The cellulose film containing the cellulose compound according to the present invention has a reverse dispersion of wavelength dispersion of in-plane retardation (Re), and advantageously allows free adjustment of the Re value and the value of the wavelength dispersion of retardation (Rth) in the thickness direction in wide ranges. In addition, the cellulose film according to the present invention can be used as an optical compensation sheet, a polarizing plate, a liquid crystal display device, or the like favorably, and shows excellent display performance.

The present invention will be described in more detail based on examples given below, but the invention is not meant to be limited by these.

### EXAMPLES

### Example 1

Cellulose acetate used as the starting material was allowed to react with an acid chloride under a condition allowing preferentially reaction at the 6-position, and then with an acid chloride different from the acid chloride used in the first reaction under a condition allowing reaction at, as well as the 6-position, the 2- and 3-positions, to give each of the cellulose compounds shown in Tables 2 and 3 and the cellulose compounds according to the present invention. Hereinafter, the method of producing each cellulose compound will be described in detail.

The molar extinction coefficients of the exemplified compounds A-1 to A-3 at the longest-wavelength absorption maximum in the range of 270 to 450 nm each were 24,000 (dichloromethane), and that of the exemplified compound A-17 was 11,400 (dichloromethane), when measured with solutions respectively containing CH₃—X¹⁶—R¹⁶, CH₃—X¹³—R¹³ and CH₃—X¹²—R¹² derived from —X₁₆—R₁₆, —X₁₃—R₁₃ and —X¹²—R₁₂, respectively.

### Synthetic Example 1

### Synthesis of Intermediate Compound B-1 (Comparative Compound)

To a 3-L three-necked flask equipped with a mechanical stirrer, a thermometer, a cooling tube, and an addition funnel, 200 g of cellulose acetate (substitution degree 2.15), 90 mL of pyridine, and 2,000 mL of acetone were placed, followed by stirring at room temperature. Thereto, 240 g of 4-phenylbenzoyl chloride (manufactured by TOKYO CHEMICAL INDUSTRY CO., LTD.) was slowly added powdery, and after the completion of the addition, the mixture was stirred for another 8 hours at 50° C. After the reaction, the reaction solution was subjected to open cooling to room temperature, and poured into 20 L of methanol while vigorously stirring, to deposit a white solid. The white solid was filtered by suction filtration, and washed three times with a large amount of methanol. The resultant white solid was dried overnight at 60° C., and then dried under vacuum for 6 hours at 90° C., to obtain 235 g of the target intermediate compound B-1 (comparative compound) as white powder. The average degree of polymerization was 255. DS¹⁶_{long and (DS}¹³_{long}+DS¹²_{long}) of the cellulose compound were as shown in Table 2 and did not satisfy the expression (I) and expression (II), respectively.

### Synthetic Example 2

### Synthesis of 4-methoxycinnamoyl chloride

To a 3-L three-necked flask equipped with a mechanical stirrer, a thermometer, a cooling tube, and an addition funnel, 200 g of 4-methoxy cinnamic acid (manufactured by TOKYO CHEMICAL INDUSTRY CO., LTD.) and 300 ml of toluene were placed, followed by stirring at room temperature. Thereto, 560 g of thionyl chloride (manufactured by Wako Pure Chemical Industries Co., Ltd.) and 10 ml of dimethylformamide was slowly added, and after the completion of the addition, the mixture was stirred for another 1 hour at 80° C. After the reaction, toluene and unreacted thionyl chloride were removed under reduced pressure, and 500 ml of hexane was added to the residue while vigorously stirring, to deposit a white solid. The white solid was filtered by suction filtration, and washed three times with a large amount of hexane. The resultant white solid was dried, to obtain 194 g of 4-methoxycinnamoyl chloride as white powder.

### Synthetic Example 3

### Synthesis of exemplified compound A-1

To a 3-L three-necked flask equipped with a mechanical stirrer, a thermometer, a cooling tube, and an addition funnel, 40 g of the above-synthesized intermediate compound B-1,400 mL of pyridine, and 100 mL of acetone were placed, followed by stirring at room temperature. Thereto, 100 g of the above-synthesized 4-methoxycinnamoyl chloride was slowly added powdery, and after the completion of the addition, the mixture was stirred for another 8 hours at 50° C. After the reaction, the reaction solution was subjected to open cooling to room temperature, and poured into 10 L of methanol while vigorously stirring, to deposit a white solid. The white solid was filtered by suction filtration, and washed three times with a large amount of methanol. The resultant white solid was dried overnight at 60° C., and then dried under vacuum for 6 hours at 90° C., to obtain 50 g of the target exemplified compound A-1 as white powder. The average degree of polymerization was 255. DS¹⁶_{long} and (DS¹³_{long}+DS¹²_{long}) of the cellulose compound were as shown in Table 1 and satisfied the expression (I) and expression (II), respectively.

### Synthetic Example 4

### Synthesis of exemplified compound A-2

In the same manner as the synthesis of the exemplified compound A-1, except that the amount of 4-methoxycinnamoyl chloride was changed from 100 g to 42 g, 46 g of the target exemplified compound A-2 was synthesized as white powder. The average degree of polymerization was 254. DS¹⁶_{long} and (DS¹³_{long}+DS¹²_{long}) of the cellulose compound were as shown in Table 1 and satisfied the expression (I) and expression (II), respectively.

### Synthetic Example 5

### Synthesis of Exemplified Compound A-3

In the same manner as the synthesis of the exemplified compound A-1, except that the amount of 4-methoxycinnamoyl chloride was changed from 100 g to 21 g, 41 g of the target exemplified compound A-3 was synthesized as white powder. The average degree of polymerization was 252. DS¹⁶_{long} and (DS¹³_{long}+DS¹²_{long}) of the cellulose compound were as shown in Table 1 and satisfied the expression (I) and expression (II), respectively.

### Synthetic Example 6

### Synthesis of Intermediate Compound B-2 (Comparative Compound)

Intermediate compound B-2 was synthesized in the same manner as the synthesis of the intermediate compound B-1, except that the amount of the acetyl cellulose was changed from 200 g to 250 g, the amount of pyridine was changed from 90 ml to 114 ml, the amount of acetone was changed from 2,000 ml To 3,000 ml, and the powdery addition of 240 g of 4-phenylbenzoyl chloride was replaced with dropwise addition of 160 ml of benzoyl chloride (manufactured by Wako Pure Chemical Industries Co., Ltd.). 210 g of the target intermediate compound (comparative example) B-2 was synthesized as white powder. The average degree of polymerization was 254. DS¹⁶_{long}, and (DS¹³_{long}+DS²_{long}) of the cellulose compound were as shown in Table 2 and did not satisfy the expression (I) and expression (II), respectively.

### Synthetic Example 7

### Synthesis of Intermediate Compound B-3 (Comparative Compound)

Intermediate compound B-3 was synthesized In the same manner as the synthesis of the intermediate compound B-1, except that the amount of pyridine was changed from 90 ml to 68 ml, and 240 g of 4-phenylbenzoyl chloride was replaced with 180 g of 4-methoxycinnamoyl chloride. 220 g of the target intermediate compound (comparative example) B-3 was synthesized as white powder. The average degree of polymerization was 255. DS¹⁶_{long} and (DS¹³_{long}+DS¹²_{long}) of the cellulose compound were as shown in Table 2 and did not satisfy the expression (I) and expression (II), respectively.

### Synthetic Example 8

### Synthesis of Intermediate Compound B-4 (Comparative Compound)

Intermediate compound B-4 was synthesized in the same manner as the synthesis of the exemplified compound A-1, except that the intermediate compound B-1 was replaced with the intermediate compound B-3, and 4-methoxycinnamoyl chloride was replaced with 4-phenylbenzoyl chloride. 48 g of the target intermediate compound (comparative example) B-4 was synthesized as white powder. The average degree of polymerization was 255. DS¹⁶_{long} and (DS¹³_{long}+DS¹²_{long}) of the cellulose compound were as shown in Table 3 and did not satisfy the expression (I) and expression (II), respectively.

### Synthetic Example 9

### Synthesis of Exemplified Compound A-17

Intermediate compound A-17 was synthesized in the same manner as the synthesis of the exemplified compound A-1, except that the intermediate compound B-1 was replaced with the intermediate compound B-2, and 100 g of 4-methoxycinnamoyl chloride was replaced with 20.5 g of 2,4,5-trimethoxybenzoyl chloride (asarylic acid chloride). 50 g of the target exemplified compound A-17 was synthesized as white powder. The average degree of polymerization was 257. DS¹⁶_{long} and (DS¹³_{long}+DS¹²_{long} of the cellulose compound were as shown in Table 1 and satisfied the expression (I) and expression (II), respectively.

The kinds, the substitution degree distribution, and the total substitution degree of the substituents on the comparative compounds (intermediate compounds) are summarized in Tables 2 and 3.

In Tables 2 and 3, DS DS¹⁶ₐᵣₒₘₐ, DS¹³ₐᵣₒₘₐ and DS¹²ₐᵣₒₘₐ each represent the substitution degree of the substituents containing an aromatic group substituting at the 6-, 3- or 2-position of the comparative cellulose compound, while DSₙₒₙ₋ₐᵣₒₘₐ represents the substitution degree of the substituents containing no aromatic group. In the case of the compounds shown in Table 2, the substituents containing an aromatic group correspond to the substituents having absorption at the longest wavelength, and DS⁶ₐᵣₒₘₐ, DS³ₐᵣₒₘₐ, and DS¹²ₐᵣₒₘₐ correspond to DS¹⁶_{long}, DS¹³_{long}, and DS¹²_{long}, respectively.

TABLE 2

| | Substituent | | Substituent | | Average |
|---|---|---|---|---|---|
| | containing aromatic | DS¹⁶ₐᵣₒₘₐ/ | containing no | | substitution |
| No | group | (DS¹²ₐᵣₒₘₐ + DS¹²ₐᵣₒₘₐ) | aromatic group | DSₙₒₙ₋ₐᵣₒₘₐ | degree |
| B-1 | 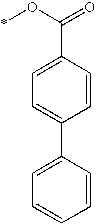 | 0.2/0.04 | 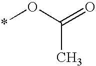 | 2.15 | 2.39 |
| B-2 | 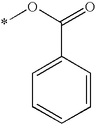 | 0.32/0.03 | 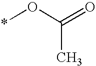 | 2.15 | 2.5 |
| B-3 | 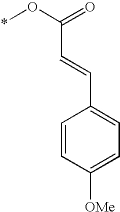 | 0.30/0.02 | 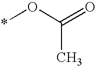 | 2.15 | 2.47 |

TABLE 3

| | Substituent having | | Substituent having | | | | |
|---|---|---|---|---|---|---|---|
| | absorption at the | | absorption at 2nd- | | Substituent containing | | |
| | longest wavelength | DS¹²_{long} + | longest-wavelength | | no aromatic group | | Average |
| | (Absorption maximum | DS¹³_{long})/ | (Absorption maximum | DS¹⁶_{long2}/ | (Absorption maximum | | degree of |
| No | wavelength) | DS¹⁶_{long} | wavelength) | DS¹²_{long2} + DS¹³_{long2}) | wavelength) | DSₙₒₙ₋ₐᵣₒₘₐ | substitution |
| B-4 | 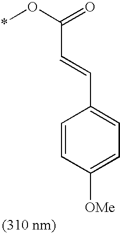 | 0.02/0.30 | 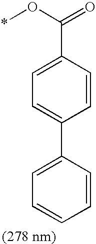 | 0.05/0.24 | 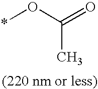 | 2.15 | 2.76 |

### Example 2

### Preparation of Cellulose Compound Solution

The following compositions were placed in a mixing tank, followed by stirring under heating, to dissolve the components, to thereby prepare a cellulose compound solution.

Cellulose compound solution

| | |
|---|---|
| Cellulose acetate (substitution degree 2.86) | 100 mass parts |
| Methylene chloride (First solvent) | 402 mass parts |
| Methanol (Second solvent) | 60 mass parts |

Each cellulose compound solution was prepared in the same manner as in the above, except that the cellulose compound A-1, A-2, A-3 or A-17 according to the present invention, or the cellulose compound B-1, B-2, B-3 or B-4 was used in place of the cellulose acetate having the substitution degree of 2.86.

<Preparation of Cellulose Film Sample Nos. 001 to 009>

The above-described cellulose compound solution in an amount of 562 parts by mass was cast using a band casting machine. The resultant film, in which the residual solvent amount was 15 mass %, was laterally oriented using a tenter, under the conditions of 160° C., at an orientation ratio of 15%, to prepare a film sample No. 009 (comparative example, thickness: 80 μm). Hereinafter, the thickness of the films prepared was 80 μm, unless specified otherwise. Then, film sample Nos. 001 to 004 according to the present invention and comparative film sample Nos. 005 to 008 were prepared similarly.

TABLE 4

| Sample | | | | | Re(450 nm)/ | Re(630 nm)/ |
|---|---|---|---|---|---|---|
| No. | Remarks | Cellulose | Re(550 nm) [nm] | Rth(550 nm) [nm] | Re(550 nm) | Re(550 nm) |
| 001 | This invention | A-1 | 102 | 220 | 0.65 | 1.21 |
| 002 | This invention | A-2 | 77 | 210 | 0.61 | 1.28 |
| 003 | This invention | A-3 | 51 | 200 | 0.52 | 1.41 |
| 004 | This invention | A-17 | 23 | 209 | 0.83 | 1.17 |
| 005 | Comparative example | B-1 | 200 | 720 | 1.11 | 0.99 |
| 006 | Comparative example | B-2 | 55 | 320 | 1.0 | 1.03 |
| 007 | Comparative example | B-3 | 68 | 400 | 1.06 | 0.96 |
| 008 | Comparative example | B-4 | 62 | 205 | 1.02 | 0.98 |
| 009 | Comparative example | Cellulose acetate | 38 | 71 | 0.75 | 1.05 |
| | | (substitution degree 2.86) | | | | |

In evaluation of the film sample, a part of each film of the samples thus obtained (120 mm×120 mm) was cut off, and the retardation was determined according to the procedure described above in the section of (optical properties of cellulose film). The results are shown in Table 4.

As obvious from the results in Table 4, the conventional cellulose acylate film and the film samples obtained in Comparative Examples did not satisfy one of the conditions of the wavelength dispersion of retardation in the plane direction represented by the following expressions.
0.5<Re(450nm)/Re(550nm)<1.0 Expression (IV)
1.05<Re(630nm)/Re(550nm)<1.5 Expression (V)

To the contrary, the film samples obtained by using the cellulose compound No. A-1, A-2, A-3 or A-4 according to the present, invention satisfied the expressions (IV) and (V), and thus showed reverse dispersion of wavelength dispersion of retardation in the plane direction, in contrast to the conventional films.

### Example 3

### Protecting Film of Polarizing Plate

The elliptical polarizing plate sample Nos. 001 to 009 were prepared according to the method described in JP-A-11-316378, Example 1, by using each of the sample Nos. 001 to 009 obtained in Example 2, and evaluated. As a result, the optical properties of the elliptical polarizing plate obtained by using the cellulose film according to the present invention were excellent.

### Example 4

### Liquid Crystal Display Device

With using each of the sample Nos. 001 to 009 obtained in Example 2, the liquid crystal display device described in JP-A-10-48420, Example 1; the optical anisotropy layer containing a discotic liquid crystal molecule described in JP-A-9-26572, Example 1; a polyvinylalcohol-coated oriented film; the VA-type liquid crystal display device described in JP-A-2000-154261, FIGS. 2 to 9; and the OCB-type liquid crystal display device described in JP-A-2000-154261, FIGS. 10 to 15 were prepared and evaluated. As a result, the device obtained by using the cellulose film according to the present invention had excellent properties in any case.

Having described our invention as related to the present embodiments, it is our intention that the invention not be limited by any of the details of the description, unless otherwise specified, but rather be construed broadly within its spirit and scope as set out in the accompanying claims.

What we claim is:

1. A cellulose film, containing a cellulose compound represented by formula (I), 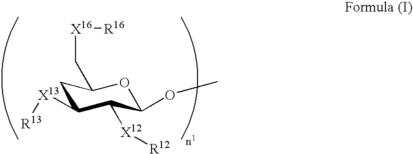
wherein, R¹⁶, R¹³, and R¹² each independently represent a hydrogen atom, or a group containing an aliphatic or aromatic group; —X¹⁶—, —X¹³—, and —X¹²— each independently represent *¹—O—, *¹—OOC—, or *¹—OOCNH— (in which *¹ represents a bond at the side of the six-membered ring of cellulose skeleton); n¹ represents an average polymerization degree of an integer of 10 to 1,500; R¹⁶, R¹³, R¹², —X¹⁶, —X¹³—, and —X¹²—, each of which is present in the number of n¹ in the cellulose compound, may be the same as or different from each other in constituting units; and the following relationships as represented by Expression (I) and Expression (II) are satisfied;
DS¹⁶_{long}<(DS¹³_{long}+DS¹²_{long}) Expression (I)
2.5≧(DS¹³_{long}+DS¹²_{long}+DS¹⁶_{long})>0.01 Expression (II)
wherein DS¹⁶_{long}, DS¹³_{long}, and DS¹²_{long} represent a substitution degree at the 6-, 3- or 2-position of the substituent having absorption at the longest wavelength, among the 3n¹ substituents substituting on the 6-, 3- or 2-position as —X¹⁶—R¹⁶, —X¹³—R¹³, or —X¹²—R¹², respectively; and said substituent having absorption at the longest wavelength is a substituent having an absorption maximum wavelength at the longest wavelength in the range of 270 to 450 nm and having a molar extinction coefficient of 2,000 to 1,000,000 for a solution of compound CH₃—X¹⁶—R¹⁶, CH₃—X¹³—R¹³ or CH₃—X¹²—R¹² corresponding to —X¹⁶—R¹⁶, —X¹³—R¹³ or —X¹²—R¹², respectively.

2. The cellulose film as claimed in claim 1, wherein the substituent having absorption at the longest wavelength among the 3n¹ substituents is a group containing an aromatic group.

3. The cellulose film as claimed in claim 1, wherein substitution degrees of the substituent having absorption at the 2nd longest wavelength among the 3n¹ substituents satisfy the following relationship as represented by Expression (III);
DS¹⁶_{long2}≧(DS¹³_{long2}+DS¹²_{long2}) Expression (III)
wherein DS¹⁶_{long2}, DS¹³_{long2}, and DS¹²_{long2}, represent a substitution degree at the 6-, 3- or 2-position of the subsistent having absorption at the 2nd longest wavelength, among the 3n¹ substituents substituting on the 6-, 3- or 2-position as —X¹⁶—R¹⁶, —X¹³—R¹³, or —X¹²—R¹², respectively.

4. The cellulose film as claimed in claim 1, wherein the substituent having absorption at the 2nd longest wavelength among the 3n¹ substitutents is a group containing an aromatic group.

5. The cellulose film as claimed in claim 1, wherein —X¹⁶—, —X¹³—, and —X¹²— each independently represent *¹—OOC— (in which *¹ represents a bond at the side of the six-membered ring of cellulose skeleton).

6. The cellulose film as claimed in claim 1, wherein at least one group among the 3n¹ groups represented by R¹⁶, R¹³, or R¹² is a group consisting of an aliphatic group.

7. The cellulose film as claimed in claim 1, wherein at least one substituent among the 3n¹ substituents represented by —X¹⁶—R¹⁶, —X¹³R¹³, or —X¹²—R¹² is —OOC—CH₃.

8. The cellulose film as claimed in claim 1, which is stretched by 0.1% to 500% at least in one direction.

9. The cellulose film as claimed in claim 8, wherein the ratio of the absolute value of in-plane retardation at 550 nm (Re(550)) to the absolute value of in-plane retardation at a given wavelength (Re(λ)) satisfies the following relationships as represented by Expressions (IV) and (V);
0.5<Re(450nm)/Re(550nm)<1.0 Expression (IV)
1.05<Re(630nm)/Re(550nm)<1.5 Expression (V)

10. A retardation film, which comprises the cellulose film as claimed in claim 1.

11. A polarizing plate, comprising a polarizing film, and two protective films which sandwich the polarizing film, wherein at least one of the two protective films is the cellulose film as claimed in claim 1.

12. A liquid crystal display device, comprising the cellulose film as claimed in claim 1.

13. A cellulose compound represented by formula (I): 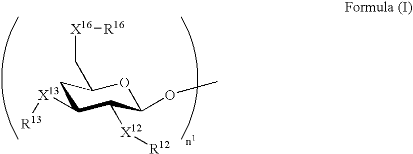
wherein, R¹⁶, R¹³ and R¹² each independently represent a hydrogen atom, or a group containing an aliphatic or aromatic group; —X¹⁶, —X¹³—, and —X¹² each independently represent *¹—O—,*¹—OOC—, or *¹—OOCNH— (in which *¹ represents a bond at the side of the six-membered ring of cellulose skeleton); n¹ represents an average polymerization degree of an integer of 10 to 1,500; R¹⁶, R¹³, R¹², —X¹⁶—, —X¹³—, and —X¹²—, each of which is present in the number of n¹ in the cellulose compound, may be the same as or different from each other in constituting units; and the following relationships as represented by Expression (I) and Expression (II) are satisfied;
DS¹⁶_{long}<(DS¹³_{long}+DS¹²_{long}) Expression (I)
2.5≧(DS¹³_{long}+DS¹²_{long}+DS¹⁶_{long})>0.01 Expression (II)
wherein DS¹⁶_{long}, DS¹³_{long}, and DS¹²_{long} represent a substitution degree at the 6-, 3- or 2-position of the substituent having absorption at the longest wavelength, among the 3n¹ substituents substituting on the 6-, 3- or 2-position as —X¹⁶—R¹⁶, —X¹³—R¹³, or —X¹²—R¹², respectively; and said substituent having absorption at the longest wavelength is a substituent having an absorption maximum wavelength at the longest wavelength in the range of 270 to 450 nm and having a molar extinction coefficient of 2,000 to 1,000,000 for a solution of compound CH₃—X¹⁶—R¹⁶, CH₃—X¹³—R¹³ or CH₃—X¹²—R¹² corresponding to —X¹⁶—R¹⁶, —X¹³—R¹³ or —X¹³—R¹², respectively.

14. The cellulose compound as claimed in claim 13, wherein at least one group among the 3n¹ groups represented by R¹⁶, R¹³, or R¹² in formula (I) is a hydrogen atom.
